(19) United States
(12) Patent Application Publication
(10) Pub. No.: US 2026/0261310 A1
(43) Pub. Date: Sep. 3, 2026

(54) REPORTING ENHANCEMENTS FOR MIXED DOWNLINK TRANSMISSIONS

(71) Applicant: Lenovo (Singapore) Pte. Limited, Singapore (SG)

(72) Inventors: Ahmed Hindy, Aurora, IL (US); Vijay Nangia, Woodridge, IL (US)

(73) Assignee: Lenovo (Singapore) Pte. Limited, Singapore (SG)

(21) Appl. No.: 19/163,732

(22) PCT Filed: Mar. 20, 2024
(86) PCT No.: PCT/IB2024/052685

§ 371 Date: Sep. 9, 2025

Related U.S. Application Data
(60) Provisional application No. 63/491,629, filed on Mar. 22, 2023.

(51) Int. Cl. H04B 7/06; H04L 5/00

(52) U.S. Cl. CPC H04B 7/0626; H04B 7/0632; H04L 5/0005; H04L 5/0044

(57) ABSTRACT

Various aspects of the present disclosure relate to an apparatus for reporting enhancements for mixed downlink transmissions. The apparatus, such as a network entity (e.g., a gNB, a UE) receives a first signaling as a channel state information (CSI) reporting setting associated with a CSI configuration for a plurality of communication modes of downlink transmissions over a physical downlink shared channel (PDSCH). The apparatus generates, based at least in part on the CSI reporting setting, a CSI report corresponding to at least one of the plurality of communication modes. The apparatus transmits a second signaling as the CSI report over a physical uplink channel.

### RELATED APPLICATION

This application claims priority to U.S. Provisional Application Ser. No. 63/491,629 filed Mar. 22, 2023 entitled “Reporting Enhancements for Mixed Downlink Transmissions,” the disclosure of which is incorporated by reference herein in its entirety.

### TECHNICAL FIELD

The present disclosure relates to wireless communications, and more specifically to mixed downlink transmissions.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Transmission of downlink data associated with different use case categories (e.g., enhanced mobile broadband (eMBB) communications, ultra-reliable low latency communications (URLLC)) is possible by using separate codewords triggered via different downlink control information (DCI) triggers for scheduling transmission of the codewords over a physical downlink shared channel (PDSCH). Due to increased wireless communication-based data transmissions associated with a variety of applications and use cases as well as the diverse capabilities of individual UEs served by a network, an overhead of transmitting separate DCI messages to schedule communication of different types of data blocks (e.g., eMBB-based and URLLC-based) or transport blocks (TBs) to a UE can have a notable impact on network resources and congestion.

### SUMMARY

The present disclosure relates to methods, apparatuses, and systems that support reporting enhancements for mixed downlink transmissions. By utilizing the described techniques, downlink data transmission and channel state reporting overhead and computational complexity is reduced, which reduces network congestion and conserves network resources (e.g., bandwidth). Aspects of the present disclosure include techniques directed at a unified channel state information (CSI) framework that supports enhanced channel state reporting for different types of transmissions (e.g., eMBB-based, URLLC-based, and mixed transmissions) transmitted from a network. The described techniques are also directed at an enhanced CSI framework that supports different repetition schemes under multi-point URLLC-based transmission from multiple network nodes, including spatial-division multiplexing (SDM), time-division multiplexing (TDM), and frequency-division multiplexing (FDM) schemes. The described techniques are also directed to a CSI framework that supports different rank indicator (RI) and channel quality indicator (CQI) hypothesis based on different assumptions of transport block (TB) type (e.g., eMBB-based, URLLC-based, or a combination thereof).

In some implementations of the method and apparatuses described herein, a UE receives, from at least one network entity, a first signaling as a CSI reporting setting associated with a CSI configuration for a plurality of communication modes of downlink transmissions over a PDSCH. The plurality of communication modes include a first communication mode for a first TB, a second communication mode for a second TB, or a third communication mode for the first TB and the second TB. The UE generates, based at least in part on the CSI reporting setting, a CSI report corresponding to at least one of the plurality of communication modes. The UE transmits a second signaling as the CSI report to the at least one network entity over a physical uplink channel.

Some implementations of the method and apparatuses described herein may further include the first TB is associated with a first TB error probability threshold and the second TB is associated with a second TB error probability threshold. The first TB error probability threshold is higher than the second TB error probability threshold. The first TB is associated with a first latency threshold and the second TB is associated with a second latency threshold. The UE receives one or more downlink reference signals (DL-RS) based on the CSI reporting setting. The CSI configuration is indicated by at least one of: a higher-layer configuration parameter in the CSI reporting setting; a higher-layer configuration parameter in a codebook configuration associated with the CSI reporting setting; a selection of at least two CQI tables associated with different TB error probability thresholds; or a repetition scheme configuration parameter of a received PDSCH configuration, the repetition scheme configuration parameter associated with time-division multiplexing, frequency-division multiplexing, or spatial-division multiplexing. the physical uplink channel includes at least one of: a physical uplink shared channel (PUSCH) based on at least one of an aperiodic time-domain behavior reporting configuration or a semi-persistent time-domain behavior reporting configuration; or a physical uplink control channel (PUCCH) based on at least one of a periodic time-domain behavior reporting configuration or a semi-persistent time-domain behavior reporting configuration. The CSI reporting setting includes an indication of a report quantity including at least one of a RI, a precoding matrix indicator (PMI), or a CQI. The CSI report includes a first pair of values associated with the first communication mode and a second pair of values associated with the second communication mode, the first pair of values including a first RI and a first CQI, the second pair of values including a second RI and a second CQI. The CSI report includes a first PMI corresponding to the first communication mode and a second PMI corresponding to the second communication mode. The CSI report includes a PMI corresponding to the first communication mode and the second communication mode. A first subset of layers of the PMI is associated with the first communication mode. A second subset of layers of the PMI is associated with the second communication mode. The CSI report includes a parameter indicating layer indices of at least one of the first subset of layers or the second subset of layers.

Additionally, the CSI report includes one or more pairs of values, each of the one or more pairs of values including a RI and a CQI. The one or more pairs of values include: a first pair of values associated with the first communication mode; a second pair of values associated with the second communication mode; a third pair of values associated with a first of two codewords corresponding to the third communication mode; and a fourth pair of values associated with a second of the two codewords corresponding to the third communication mode. The CSI report includes a first PMI associated with the first communication mode and a second PMI associated with the second communication mode. A first subset of layers of the first PMI is associated with a first codeword corresponding to the third communication mode. A second subset of layers of the second PMI is associated with the second codeword corresponding to the third communication mode. The CSI report includes a parameter indicating layer indices of at least one of the first subset of layers or the second subset of layers. the CSI report includes: a first layer indicator indicating a first layer index corresponding to the first subset of the layers; and a second layer indicator indicating a second layer index corresponding to the second subset of layers. A codeword corresponding to the second TB is transmitted over the PDSCH using a first set of resources associated with a first network entity and a second set of resources associated with a second network entity. The first set of resources includes time resources, frequency resources, or a pair of time and frequency resources. The second set of resources includes time resources, frequency resources, or a pair of time and frequency resources. The first communication mode corresponds to a mobile broadband communication mode. The second communication mode corresponds to at least one of a high reliability communication mode or a low latency communication mode. A codeword corresponding to the second TB is associated with two non-zero power channel state information reference signal (NZP-CSI-RS) resources for channel measurement.

Additionally, a codeword corresponding to the second TB is associated with a demodulation reference signal (DMRS) that includes a first group of DMRS ports and a second group of DMRS ports. The first group of DMRS ports is quasi-co-located with a first NZP-CSI-RS resource. The second group of the DMRS ports is quasi-co-located with a second NZP-CSI-RS resource. The CSI reporting setting is configured to override one or more other CSI reporting settings received by the apparatus prior to receipt of the CSI reporting setting. A number of CSI processing units (CPUs) associated with the CSI reporting setting corresponds to a maximum number of CPUs available at the apparatus. The UE generates, based at least in part on the CSI reporting setting, at least one of a first CSI report corresponding the first communication mode, a second CSI report corresponding to the second communication mode, and a third CSI report corresponding to the third communication mode. Each of the at least one of the first CSI report, the second CSI report, and the third CSI report includes at least one of a RI, a PMI, or a CQI.

In some implementations of the method and apparatuses described herein, a network entity transmits a first signaling as a CSI reporting setting associated with a CSI configuration for a plurality of communication modes of downlink transmissions over a PDSCH. The plurality of communication modes including a first communication mode for a first TB, a second communication mode for a second TB, or a third communication mode for the first TB and the second TB. The network entity receives, over a physical uplink channel, a second signaling as a CSI report corresponding to at least one of the plurality of communication modes.

Some implementations of the method and apparatuses described herein may further include the first TB being associated with a first TB error probability threshold and the second TB being associated with a second TB error probability threshold. The first TB error probability threshold is higher than the second TB error probability threshold. The first TB is associated with a first latency threshold and the second TB is associated with a second latency threshold. The network entity transmits one or more DL-RS based on the CSI reporting setting. The CSI configuration is indicated by at least one of: a higher-layer configuration parameter in the CSI reporting setting; a higher-layer configuration parameter in a codebook configuration associated with the CSI reporting setting; a selection of at least two CQI tables associated with different TB error probability thresholds; or a repetition scheme configuration parameter of a received PDSCH configuration, the repetition scheme configuration parameter associated with time-division multiplexing, frequency-division multiplexing, or spatial-division multiplexing. the physical uplink channel includes at least one of: a PUSCH based on at least one of an aperiodic time-domain behavior reporting configuration or a semi-persistent time-domain behavior reporting configuration; or a PUCCH based on at least one of a periodic time-domain behavior reporting configuration or a semi-persistent time-domain behavior reporting configuration. The CSI reporting setting includes an indication of a report quantity including at least one of a RI, a PMI, or a CQI. The CSI report includes a first pair of values associated with the first communication mode and a second pair of values associated with the second communication mode, the first pair of values including a first RI and a first CQI, the second pair of values including a second RI and a second CQI. The CSI report includes a first PMI corresponding to the first communication mode and a second PMI corresponding to the second communication mode. The CSI report includes a PMI corresponding to the first communication mode and the second communication mode. A first subset of layers of the PMI is associated with the first communication mode. A second subset of layers of the PMI is associated with the second communication mode. The CSI report includes a parameter indicating layer indices of at least one of the first subset of layers or the second subset of layers.

Additionally, the CSI report includes one or more pairs of values, each of the one or more pairs of values including a RI and a CQI. The one or more pairs of values include: a first pair of values associated with the first communication mode; a second pair of values associated with the second communication mode; a third pair of values associated with a first of two codewords corresponding to the third communication mode; and a fourth pair of values associated with a second of the two codewords corresponding to the third communication mode. The CSI report includes a first PMI associated with the first communication mode and a second PMI associated with the second communication mode. A first subset of layers of the first PMI is associated with a first codeword corresponding to the third communication mode. A second subset of layers of the second PMI is associated with the second codeword corresponding to the third communication mode. The CSI report includes a parameter indicating layer indices of at least one of the first subset of layers or the second subset of layers. the CSI report includes: a first layer indicator indicating a first layer index corresponding to the first subset of the layers; and a second layer indicator indicating a second layer index corresponding to the second subset of layers. A codeword corresponding to the second TB is transmitted over the PDSCH using a first set of resources associated with a first network entity and a second set of resources associated with a second network entity. The first set of resources includes time resources, frequency resources, or a pair of time and frequency resources. The second set of resources includes time resources, frequency resources, or a pair of time and frequency resources. The first communication mode corresponds to a mobile broadband communication mode. The second communication mode corresponds to at least one of a high reliability communication mode or a low latency communication mode. A codeword corresponding to the second TB is associated with two NZP-CSI-RS resources for channel measurement.

Additionally, a codeword corresponding to the second TB is associated with a DMRS that includes a first group of DMRS ports and a second group of DMRS ports. The first group of DMRS ports is quasi-co-located with a first NZP-CSI-RS resource. The second group of the DMRS ports is quasi-co-located with a second NZP-CSI-RS resource. The CSI reporting setting is configured to override one or more other CSI reporting settings received by the apparatus prior to receipt of the CSI reporting setting. A number of CSI processing units (CPUs) associated with the CSI reporting setting corresponds to a maximum number of CPUs available at the apparatus. The network entity receives from a UE, based at least in part on the CSI reporting setting, at least one of a first CSI report corresponding the first communication mode, a second CSI report corresponding to the second communication mode, and a third CSI report corresponding to the third communication mode. Each of the at least one of the first CSI report, the second CSI report, and the third CSI report includes at least one of a RI, a PMI, or a CQI.

### BRIEF DESCRIPTION OF THE DRAWINGS

FIG. 1 illustrates an example of a wireless communications system that supports reporting enhancements for mixed downlink transmissions in accordance with aspects of the present disclosure.

FIG. 2 illustrates an example of aperiodic trigger state defining a list of CSI report settings, as related to reporting enhancements for mixed downlink transmissions in accordance with aspects of the present disclosure.

FIG. 3 illustrates an example of aperiodic trigger state that indicates the resource set and quasi co-located (QCL) information, as related to reporting enhancements for mixed downlink transmissions in accordance with aspects of the present disclosure.

FIG. 4 illustrates an example of a RRC configuration for (a) a NZP-CSI-RS resource and (b) a CSI-IM resource, as related to reporting enhancements for mixed downlink transmissions in accordance with aspects of the present disclosure.

FIG. 5 illustrates an example of a partial CSI omission for PUSCH-based CSI, as related to reporting enhancements for mixed downlink transmissions in accordance with aspects of the present disclosure.

FIG. 6 illustrates an example of abstract syntax notation one (ASN-1) code for configuring an NZP-CSI-RS resource set, as related to reporting enhancements for mixed downlink transmissions in accordance with aspects of the present disclosure.

FIG. 7 illustrates an example of tracking reference signal (TRS) configuration, as related to reporting enhancements for mixed downlink transmissions in accordance with aspects of the present disclosure.

FIG. 8 illustrates an example of ASN-1 code for QCL information, as related to reporting enhancements for mixed downlink transmissions in accordance with aspects of the present disclosure.

FIG. 9 illustrates an example of ASN-1 code for PDSCH-Config information Element (IE), as related to reporting enhancements for mixed downlink transmissions in accordance with aspects of the present disclosure.

FIG. 10 illustrates an example of ASN-1 code for DMRS-DownlinkConfig, as related to reporting enhancements for mixed downlink transmissions in accordance with aspects of the present disclosure.

FIGS. 11A and 11B illustrate an example of DMRS patterns for mapping Type A with front-load DMRS, as related to reporting enhancements for mixed downlink transmissions in accordance with aspects of the present disclosure.

FIG. 12 illustrates an example of ASN-1 code for an implementation where an RRC parameter is included in the CSI reporting setting, as related to reporting enhancements for mixed downlink transmissions in accordance with aspects of the present disclosure.

FIG. 13 illustrates an example of ASN-1 code for an implementation where an RRC parameter is included in the codebook configuration, as related to reporting enhancements for mixed downlink transmissions in accordance with aspects of the present disclosure.

FIG. 14 illustrates an example 1400 of ASN-1 code for an implementation where a value of a first higher-layer parameter corresponds to a codepoint mapped to two CQI tables, as related to reporting enhancements for mixed downlink transmissions in accordance with aspects of the present disclosure.

FIG. 15 illustrates an example of ASN-1 code for an implementation that includes a second higher-layer parameter to indicate a joint DL transmission, as related to reporting enhancements for mixed downlink transmissions in accordance with aspects of the present disclosure.

FIG. 16 illustrates an example of a wireless communication system in which two transmission reception points (TRPs) are transmitting an eMBB-based codeword and a URLLC-based codeword to a UE, as related to reporting enhancements for mixed downlink transmissions in accordance with aspects of the present disclosure.

FIGS. 17 and 18 illustrate an example of a block diagram of devices that supports reporting enhancements for mixed downlink transmissions in accordance with aspects of the present disclosure.

FIGS. 19-22 illustrate flowcharts of methods that support reporting enhancements for mixed downlink transmissions in accordance with aspects of the present disclosure.

### DETAILED DESCRIPTION

A wireless communications system supports different use case categories for downlink signaling. Each use case category may have its own set of requirements. For example, eMBB communications are typically associated with relatively high connection throughput and/or network capacity requirements. As another example, URLLC communications are typically associated with relatively moderate throughput requirements, high reliability requirements, and/or low latency requirements. The system may accommodate different TB transmission requirements (e.g., throughput, reliability, latency, etc.) by configuring underlying transmit signal parameters (e.g., beamforming, resources, codebook selection, etc.). While supporting different TB configurations enables a variety of communication use cases and applications, signaling overhead (e.g., CSI reports) associated with measuring and adjusting link conditions to achieve the target TB transmission requirements can have a notable impact on network congestion and resource availability.

Furthermore, conventional solutions such as using a separate CSI reporting setting for two different types of TBs (e.g., eMBB-based and URLLC-based), accurate and/or effective CSI reports for transmissions that include a concurrent transmission of two types of TBs (e.g., both eMBB-based and URLLC-based) is not possible. Moreover, CSI feedback overhead is increased if two separate CSI reports corresponding to the two transport blocks are to be signaled for a single transmission. Furthermore, although scheduling-based coordination of eMBB-based and URLLC-based downlink (DL) transmissions at the network side allows the network to manage time/frequency resources to enable transmission of both TBs on separate resources with respective target rules, no physical layer-based coordination takes place in terms of interference management, dynamic resource coordination mapping, etc., which leads to inefficient time, frequency, and power resource utilization.

In aspects of reporting enhancements for mixed downlink transmissions, this disclosure describes details for reducing signaling overhead associated with channel state reporting and/or configuration of downlink data transmissions, which reduces network congestion and/or resource consumption (e.g., by a network entity or network entities at network nodes in a wireless communication system). The described techniques also enable a unified CSI reporting framework for transmissions that include different types of TBs as well as concurrent transmissions of more than one type of TB, which improves network performance and network resource utility.

In further aspects of reporting enhancements for mixed downlink transmissions, this disclosure describes details for an enhanced CSI framework that supports different repetition schemes under multi-point URLLC-based transmission from multiple network nodes, including SDM, TDM, and FDM schemes. The described techniques are also directed to a unified CSI framework that supports different transmission types, including eMBB-based TB transmissions, URLLC-based TB transmissions, or a joint transmission of two different types of TBs. The described techniques are also directed to details for supporting different RI and CQI hypotheses based on different assumptions of TB types.

Aspects of the present disclosure are described in the context of a wireless communications system. Aspects of the present disclosure are further illustrated and described with reference to device diagrams and flowcharts.

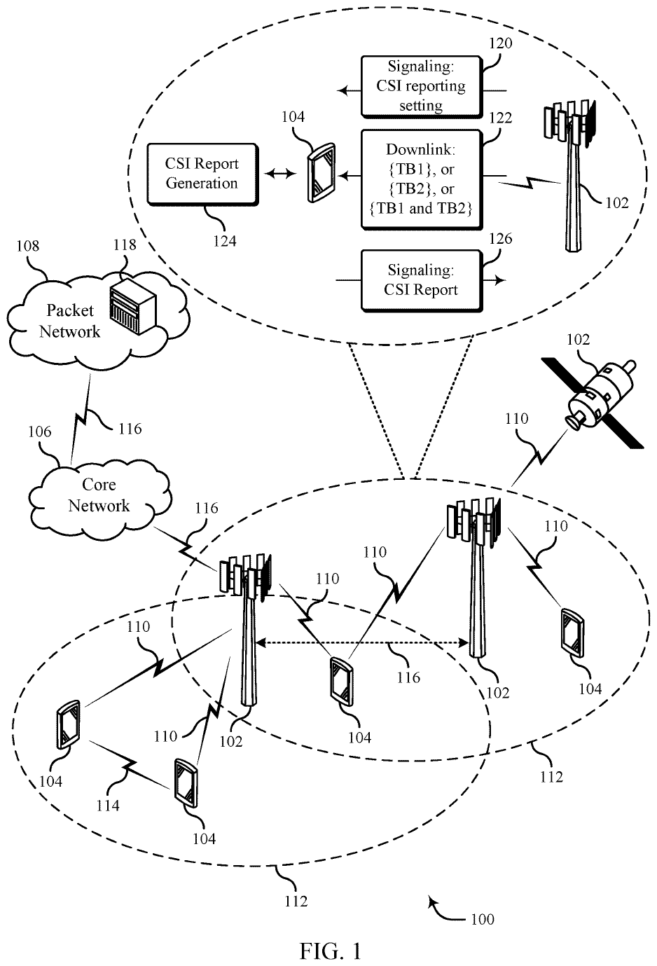

FIG. 1 illustrates an example of a wireless communications system 100 that supports reporting enhancements for mixed downlink transmissions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of reporting enhancements for mixed downlink transmissions, as described herein. For instance, a network entity 102 (e.g., a base station) communicates a first signaling 120 that includes various information, such as a CSI reporting setting. The CSI reporting setting pertains to CSI configurations for a multiple communication modes of downlink transmissions over a PDSCH (e.g., eMBB-based, URLLC-based, joint transmission of an eMBB-based and URLLC-based TBs, etc.). More generally, in examples, the multiple communication modes include a first communication mode for a first TB (e.g., TB1), a second communication mode for a second TB (e.g., TB2), and/or a third communication mode for a joint transmission of the first TB and the second TB. The network entity 102 also transmits a downlink transmission 122 according to one of the multiple communication modes (e.g., TB1, TB2, or a joint transmission of TB1 and TB2). The UE 104 receives the first signaling 120 and the downlink transmission 122. The UE 104 then generates, based on the CSI reporting setting, a CSI report 124 that is appropriate for the communication mode of the downlink transmission 122. For instance, the UE 104 generates a first CSI report if the downlink transmission included a first type of TB (e.g., TB1) different than a second CSI report for the second type of TB (e.g., TB2) or a third CSI report for a joint transmission of the two types of TBs (e.g., TB1 and TB2). The UE 104 then transmits a second signaling 126 indicating the generated CSI report. In various examples, the base station uses the CSI report from the UE 104 to adapt and/or improve the link between the UE 104 and the base station, and/or to plan future downlink transmissions to the UE 104.

With reference to NR codebook types and timing for CSI reporting, new radio (5GNR) codebook types are taken into consideration, such as Type-II Codebook. With reference to NR (Rel. 15) Type-II codebook, a gNB can be equipped with a two-dimensional (2D) antenna array with N₁, N₂ antenna ports per polarization placed horizontally and vertically, and communication occurs over N₃ PMI sub-bands. A PMI sub-band consists of a set of resource blocks, with each resource block consisting of a set of subcarriers. In this case, 2N₁N₂ CSI-RS ports are utilized to enable downlink channel estimation with high resolution for NR (Rel. 15) Type-II codebook. In order to reduce the uplink (UL) feedback overhead, a discrete Fourier transform (DFT)-based CSI compression of the spatial domain is applied to L dimensions per polarization, where L<N₁N₂. In the sequel, the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer/takes on the form:

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ]$$

$${v}_{l , m} = {[ {u}_{m} {e}^{j \frac{2 π l}{{O}_{1} {N}_{1}}} {u}_{m} … {e}^{j \frac{2 π m ( {N}_{2} - 1 )}{{O}_{1} {N}_{1}}} {u}_{m} ]}^{T}$$

$$B = [ {v}_{{l}_{0} , {m}_{0}} {v}_{{l}_{1} , {m}_{1}} … {v}_{{l}_{L - 1} , {m}_{L - 1}} ]$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation. Note that O₁, O₂ oversampling factors are assumed for the 2D DFT matrix from which matrix B is drawn. Note that W₁ is common across all layers. W_{2,l} is a 2L×N3 matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,l} are independent for different layers.

With reference to NR (Rel. 15) Type-II Port Selection codebook, only K (where K≤2N₁N₂) beamformed CSI-RS ports are utilized in a DL transmission, in order to reduce complexity. The K×N₃ codebook matrix per layer takes on the form:

$${W}_{l} = {W}_{1}^{PS} {W}_{2 , l} .$$

Here, W₂ follow the same structure as the conventional NR Type-II Codebook, and are layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{PS} {d}_{PS} + L - 1 , K / 2}^{( K / 2 )} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

$$[ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

With reference to NR (Rel. 15) Type-I codebook, the Type-I codebook is the baseline codebook for NR, with a variety of configurations. The most common utility of the Type-I codebook is a special case of NR Type-II codebook with L=1 for RI=1,2, wherein a phase coupling value is reported for each sub-band, i.e., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁ . . . =φ, i.e., wideband reporting. For RI>2 different beams are used for each pair of layers. The NR Type-I codebook can be depicted as a low-resolution version of NR Type-II codebook with spatial beam selection per layer-pair and phase combining only.

With reference to NR (Rel. 16) Type-II codebook, a gNB can be equipped with a two-dimensional (2D) antenna array with N₁, N₂ antenna ports per polarization placed horizontally and vertically and communication occurs over N₃ PMI sub-bands. A PMI sub-band consists of a set of resource blocks, with each resource block consisting of a set of subcarriers. In this case, 2N₁N₂N₃ CSI-RS ports are utilized to enable DL channel estimation with high resolution for NR (Rel. 16) Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{i} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${v}_{l , m} = [ \begin{matrix}1 & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ] ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}}\end{matrix} ] ,$$

$${l}_{i} = {O}_{1} {n}_{1}^{( i )} + {q}_{1} ,$$

$$0 \leq {n}_{1}^{( i )} < {N}_{1} ,$$

$$0 \leq {q}_{1} < {O}_{1} ,$$

$${m}_{i} = {O}_{2} {n}_{2}^{( i )} + {q}_{2} ,$$

$$0 \leq {n}_{2}^{( i )} < {N}_{2} ,$$

$$0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$${W}_{f , l} = [ \begin{matrix}{f}_{{k}_{0}} & {f}_{{k}_{1}} & ⋯ & {f}_{{k}_{{M}^{′} - 1}}\end{matrix} ] ,$$

$$0 \leq {k}_{i} \leq {N}_{3} - 1 ,$$

$${f}_{k} = {[ \begin{matrix}1 & {e}^{- j \frac{2 π k}{{N}_{3}}} & ⋯ & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred to as the selected frequency domain (FD) basis indices. Hence, L, M represent the equivalent spatial and frequency dimensions after compression, respectively. Finally, the 2L×MV matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, compared with 2N₁N₂×N₃−1 coefficients of a theoretical design.

For the Type-II Port Selection codebook (Rel. 16), only K (where K≤2N₁N₂) beamformed CSI-RS ports are utilized in DL transmission, in order to reduce complexity. The K×N₃ codebook matrix per layer takes on the form:

$${W}_{i} = {W}_{1}^{PS} {\tilde{W}}_{2 , l} {W}_{f , l}^{H} .$$

Here, \tilde{W}_{2,l} and W_{f,l} follow the same structure as the conventional NR (Rel. 16) Type-II Codebook, where both are layer specific. The matrix

$${W}_{1}^{PS}$$

is a K×2L block-diagonal matrix with the same structure as that in the NR (Rel. 15) Type-II Port Selection codebook.

The NR (Rel. 17) Type-II Port Selection codebook follows a similar structure as that of Rel. 15 and Rel. 16 port-selection codebooks, as follows:

$${W}_{i} = {W}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

With reference to CSI reporting, the codebook report is partitioned into two parts based on the priority of information reported. Each part is encoded separately (Part 1 has a possibly higher code rate). Below, only the parameters for NR (Rel. 16) Type-II codebook are listed. With reference to the content of a CSI report, a Part 1 is RI+CQI+total number of coefficients. A Part 2 is SD basis indicator+FD basis indicator/layer+bitmap/layer+coefficient amplitude info/layer+coefficient phase info/layer+strongest coefficient indicator/layer. Furthermore, Part 2 CSI can be decomposed into sub-parts, each with different priority (higher priority information listed first). Such partitioning is required to allow dynamic reporting size for a codebook based on available resources in the UL phase. Additionally, Type-II codebook is based on aperiodic CSI reporting, and only reported in PUSCH via DCI triggering (one exception). Type-I codebook can be based on periodic CSI reporting (PUCCH) or semi-persistent CSI reporting (PUSCH or PUCCH) or aperiodic reporting (PUSCH).

With reference to reporting CSI report Part 2, note that multiple CSI reports may be transmitted with different priorities, as shown below in Table 1.

Note that the priority of the N_{Rep} CSI reports are based on the following: (1) a CSI report corresponding to one CSI reporting configuration for one cell may have higher priority compared with another CSI report corresponding to one other CSI reporting configuration for the same cell; (2) CSI reports intended to one cell may have higher priority compared with other CSI reports intended to another cell; (3) CSI reports may have higher priority based on the CSI report content (e.g., CSI reports carrying L1-reference signal received power (RSRP) information have higher priority); and (4) CSI reports may have higher priority based on their type (e.g., whether the CSI report is aperiodic, semi-persistent or periodic, and whether the report is sent via PUSCH or PUCCH, may impact the priority of the CSI report). In light of that, CSI reports may be prioritized as follows, where CSI reports with lower identifiers (IDs) have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1-Signal-to-Interference-and-Noise Ratio, 1 otherwise
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI.
Priority 0:
For CSI reports 1 to N_{Rep}, Group 0 CSI for CSI reports
configured as ‘typeII-r16’ or ‘typeII-PortSelection-r16’; Part 2
wideband CSI for CSI reports configured otherwise
Priority 1:
Group 1 CSI for CSI report 1, if configured as ‘typeII-r16’ or
‘typeII-PortSelection-r16’; Part 2 sub-band CSI of even
sub-bands for CSI report 1, if configured otherwise
Priority 2:
Group 2 CSI for CSI report 1, if configured as ‘typeII-r16’ or
‘typeII-PortSelection-r16’; Part 2 sub-band CSI of odd
sub-bands for CSI report 1, if configured otherwise
Priority 3:
Group 1 CSI for CSI report 2, if configured as ‘typeII-r16’ or
‘typeII-PortSelection-r16’; Part 2 sub-band CSI of even
sub-bands for CSI report 2, if configured otherwise
Priority 4:
Group 2 CSI for CSI report 2, if configured as ‘typeII-r16’ or
‘typeII-PortSelection-r16’. Part 2 sub-band CSI of odd
sub-bands for CSI report 2, if configured otherwise
Priority 2N_{Rep}-1:
Group 1 CSI for CSI report N_{Rep}, if configured as ‘typeII-r16’
or ‘typeII-PortSelection-r16’; Part 2 sub-band CSI of even
sub-bands for CSI report N_{Rep}, if configured otherwise
Priority 2NRep:
Group 2 CSI for CSI report N_{Rep}, if configured as ‘typeII-r16’
or ‘typeII-PortSelection-r16’; Part 2 sub-band CSI of odd
sub-bands for CSI report N_{Rep}, if configured otherwise

With reference to triggering aperiodic CSI reporting on PUSCH, a UE needs to report the needed CSI information for the network using the CSI framework in NR. (Rel. 15). The triggering mechanism between a report setting and a resource setting can be summarized as shown below in Table 2.

TABLE 2
Triggering mechanism between a report setting and a resource setting.

| | | Periodic CSI | | AP CSI |
|---|---|---|---|---|
| | | reporting | SP CSI reporting | Reporting |
| Time Domain | Periodic | RRC | MAC CE (PUCCH) | DCI |
| | CSI-RS | configured | DCI (PUSCH) | |
| Behavior of | SP | Not | MAC CE (PUCCH) | DCI |
| | CSI-RS | Supported | DCI (PUSCH) | |
| Resource | AP | Not | Not Supported | DCI |
| Setting | CSI-RS | Supported | | |

Moreover, all associated resource settings for a CSI report setting need to have the same time domain behavior. Periodic CSI-RS/interference management (IM) resource and CSI reports are assumed to be present and active once configured by radio resource control (RRC). Aperiodic and semi-persistent CSI-RS/IM resources and CSI reports are explicitly triggered or activated. For aperiodic CSI-RS/IM resources and aperiodic CSI reports, the triggering is performed jointly by transmitting a DCI format 0-1. Semi-persistent CSI-RS/IM resources and semi-persistent CSI reports are independently activated.

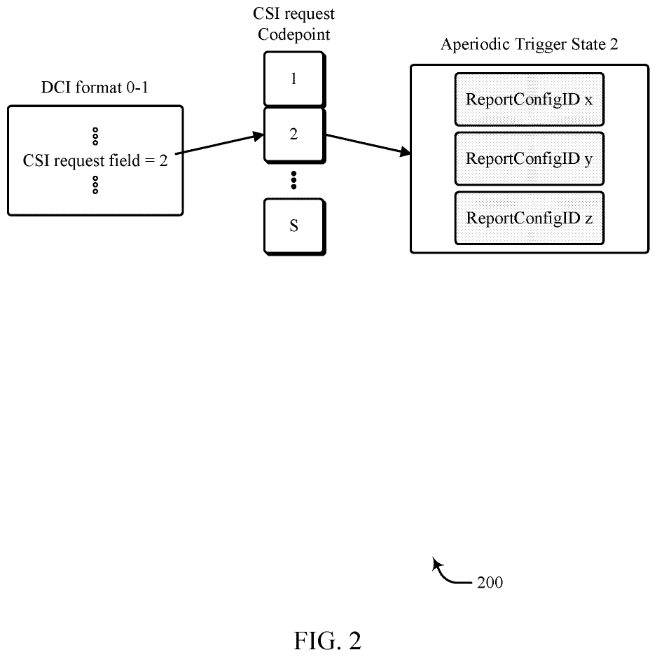

FIG. 2 illustrates an example 200 of aperiodic trigger state defining a list of CSI report settings as related to reporting enhancements for mixed downlink transmissions in accordance with aspects of the present disclosure. In this example 200, for aperiodic CSI-RS/IM resources and aperiodic CSI reports, the triggering is performed jointly by transmitting a DCI format 0-1. The DCI format 0_1 contains a CSI request field (0 to 6 bits). A non-zero request field points to an aperiodic trigger state configured by RRC. An aperiodic trigger state in turn is defined as a list of up to sixteen (16) aperiodic CSI report settings, identified by a CSI report setting ID for which the UE calculates simultaneously CSI and transmits it on the scheduled PUSCH transmission.

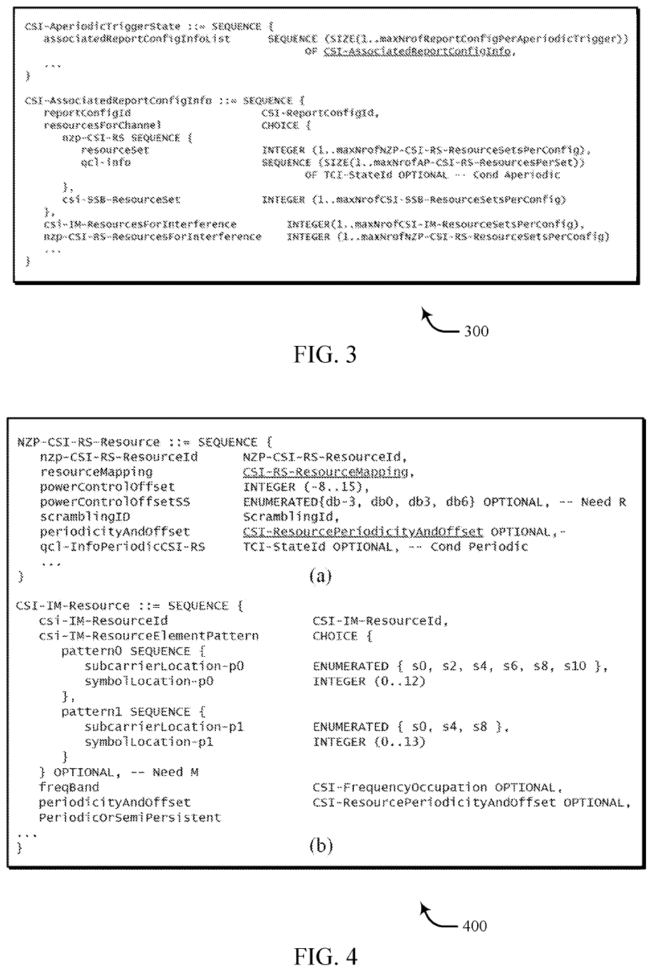

FIG. 3 illustrates an example 300 of aperiodic trigger state that indicates the resource set and QCL information as related to reporting enhancements for mixed downlink transmissions in accordance with aspects of the present disclosure. This example 300 indicates that when the CSI report setting is linked with an aperiodic resource setting (which may include multiple resource sets), the aperiodic NZP-CSI-RS resource set for channel measurement, the aperiodic CSI-IM resource set (if used), and the aperiodic NZP-CSI-RS resource set for IM (if used) to use for a given CSI report setting are also included in the aperiodic trigger state definition, as shown in this example 300. For aperiodic NZP-CSI-RS, the QCL source to use is also configured in the aperiodic trigger state. The UE assumes that the resources used for the computation of the channel and interference can be processed with the same spatial filter (i.e. quasi-co-located with respect to “QCL-TypeD”).

FIG. 4 illustrates an example 400 of a RRC configuration for (a) an NZP-CSI-RS resource and (b) CSI-IM resource as related to reporting enhancements for mixed downlink transmissions in accordance with aspects of the present disclosure. This example 400 indicates the RRC configuration for NZP-CSI-RS/CSI-IM resources. A Table 3 below summarizes the type of UL channels used for CSI reporting as a function of the CSI codebook type.

TABLE 3
UL channels used for CSI reporting as a function of the
CSI codebook type.

| | Periodic CSI | SP CSI | AP CSI |
|---|---|---|---|
| | reporting | reporting | reporting |
| Type I WB | PUCCH | PUCCH Format 2 | PUSCH |
| | Format 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

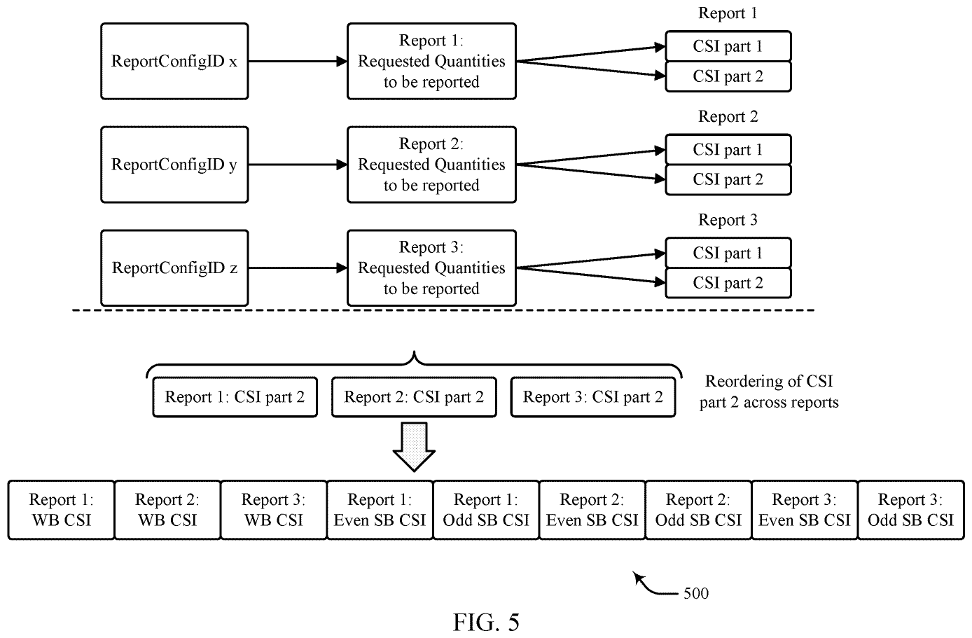

FIG. 5 illustrates an example 500 of a partial CSI omission for PUSCH-based CSI as related to reporting enhancements for mixed downlink transmissions in accordance with aspects of the present disclosure. For aperiodic CSI reporting, PUSCH-based reports are divided into two CSI parts, CSI Part1 and CSI Part 2, because the size of CSI payload varies significantly, and therefore a worst-case uplink control information payload size design would result in large overhead. CSI Part 1 has a fixed payload size (and can be decoded by the gNB without prior information) and contains the following: RI (if reported), CSI-RS resource index (CRI) (if reported), and CQI for the first codeword; and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in this example 500.

As described, CSI reports are prioritized according to several factors, including the time-domain behavior and physical channel, where more dynamic reports are given precedence over less dynamic reports and PUSCH has precedence over PUCCH; CSI content, where beam reports (i.e. L1-RSRP reporting) has priority over regular CSI reports; the serving cell to which the CSI corresponds (in case of carrier aggregation (CA) operation), and CSI corresponding to the PCell has priority over CSI corresponding to Scells; and the reportConfigID.

With reference to CQI reporting, a CSI report may include a CQI report quantity corresponding to channel quality assuming a maximum target transport block error rate, which indicates a modulation order, a code rate, and a corresponding spectral efficiency associated with the modulation order and code rate pair. Examples of the maximum transport block error rates are 0.1 and 0.00001. The modulation order can vary from quadrature phase-shift keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4 below.

A CQI value may be reported in two formats: a wideband format, wherein one CQI value is reported corresponding to each PDSCH transport block, and a sub-band format, where one wideband CQI value is reported for the entire transport block, in addition to a set of sub-band CQI values corresponding to CQI sub-bands on which the transport block is transmitted. CQI sub-band sizes are configurable, and depends on the number of PRBs in a bandwidth part, as shown in Table 5 below.

TABLE 4
Example of a 4-bit CQI table.

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 5
Configurable sub-band sizes for a given
bandwidth part (BWP) size.

| Bandwidth part (PRBs) | Sub-band size (PRBs) |
|---|---|
| 24-72 | 4, 8 |
| 73-144 | 8,16 |
| 145-275 | 16, 32 |

If the higher layer parameter cqi-BitsPerSubband in a CSI reporting setting CSI-ReportConfig is configured, sub-band CQI values are reported in a full form (i.e., using 4 bits for each sub-band CQI based on a CQI table, e.g., Table 4). If the higher layer parameter cqi-BitsPerSubband in CSI-ReportConfig is not configured, for each sub-band s, a 2-bit sub-band differential CQI value is reported, defined as:

$$Sub - band Offset level ( s ) = sub - band CQI index ( s ) - wideband CQI index$$

The mapping from the 2-bit sub-band differential CQI values to the offset level is shown in Table 6 below.

TABLE 6
Mapping sub-band differential CQI value to offset level.

| Sub-band differential CQI value | Offset level |
|---|---|
| 0 | 0 |
| 1 | 1 |
| 2 | ≥2 |
| 3 | ≤−1 |

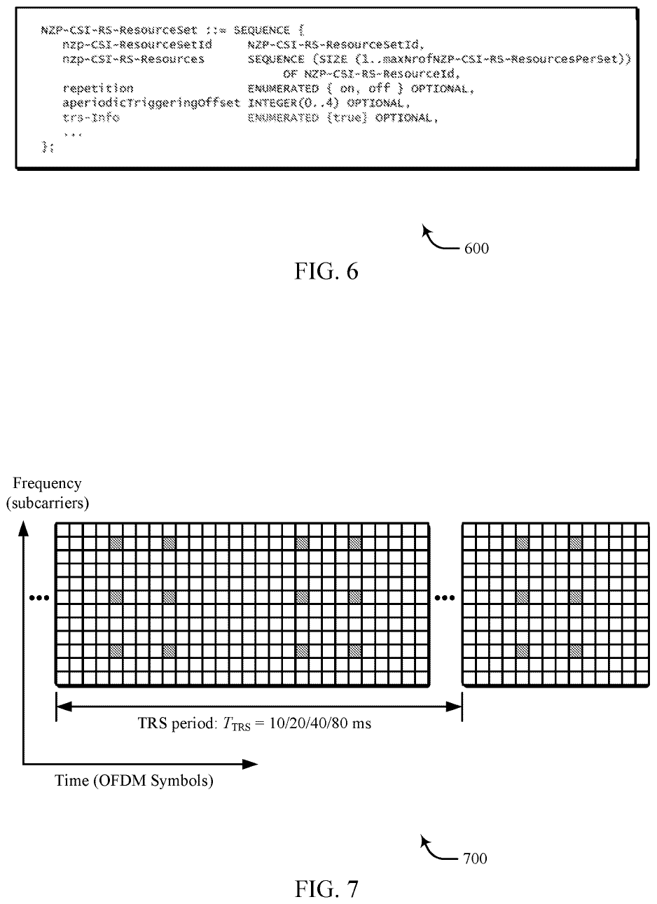

FIG. 6 illustrates an example 600 of ASN-1 code for configuring an NZP-CSI-RS resource set, as related to reporting enhancements for mixed downlink transmissions in accordance with aspects of the present disclosure. Aspects of reporting enhancements for mixed downlink transmissions include and/or are directed to TRS, which is transmitted for establishing fine time and frequency synchronization at a UE to aid in demodulation of PDSCH, particularly for higher order modulations. A TRS is an NZP-CSI-RS resource set with “TRS-info” set to true. As shown in the example 600, “trs-info” indicates that the antenna port for all NZP-CSI-RS resources in the CSI-RS resource set is the same. The TRS contains either 2 or 4 periodic CSI-RS resources with periodicity 2^{-μ}*Xp slots where Xp=10, 20, 40, or 80 and where is related to the sub carrier spacing, i.e. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 7.

FIG. 7 illustrates an example 700 of TRS configuration, as related to reporting enhancements for mixed downlink transmissions in accordance with aspects of the present disclosure. In this example 700, the two CSI-RS within a slot are always separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set {1 to 8}. The maximum number of TRS resource sets configured to UE per CC: Candidate value set: {1 to 64}. the UE is mandated to report at least 8 for FR1 and 16 for FR2. The maximum number of TRS resource sets configured to UE across CCs: Candidate value set: {1 to 256}. UE is mandated to report at least 16 for FR1 and 32 for FR2. Furthermore, an aperiodic TRS is a set of aperiodic CSI-RS for tracking that is optionally configured, but a periodic TRS always needs to be configured, and its time and frequency domain configurations (except for the periodicity) must match those of the periodic TRS. The UE may assume that the aperiodic TRS resources are quasi-co-located with the periodic TRS resources.

FIG. 8 illustrates an example 800 of ASN-1 code for QCL information, as related to reporting enhancements for mixed downlink transmissions in accordance with aspects of the present disclosure. In this example 800, a transmission configuration indicator (TCI) state (in example 800 and as configured by RRC) will have two QCL types (i.e., two reference signals) with the second QCL type only for operation in FR2.

With reference to DMRS and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a synchronization signal block (SSB). The DMRS is used to estimate channel coefficients for coherent detection of the physical channels. For downlink, the DMRS is subject to the same precoding as the PDSCH. NR first defines two time-domain structures for DMRS according to the location of the first DMRS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the code division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

FIG. 9 illustrates an example 900 of ASN-1 code for PDSCH-Config IE, as related to reporting enhancements for mixed downlink transmissions in accordance with aspects of the present disclosure. In this example 900, note that the configuration of the DMRS Type is provided through higher-layer signaling independently for each PDSCH and PUSCH, each mapping Type (A or B), and each BWP independently (see the RRC configuration). The PDSCH-Config IE, as shown in example 900, is used to configure the UE specific PDSCH parameters.

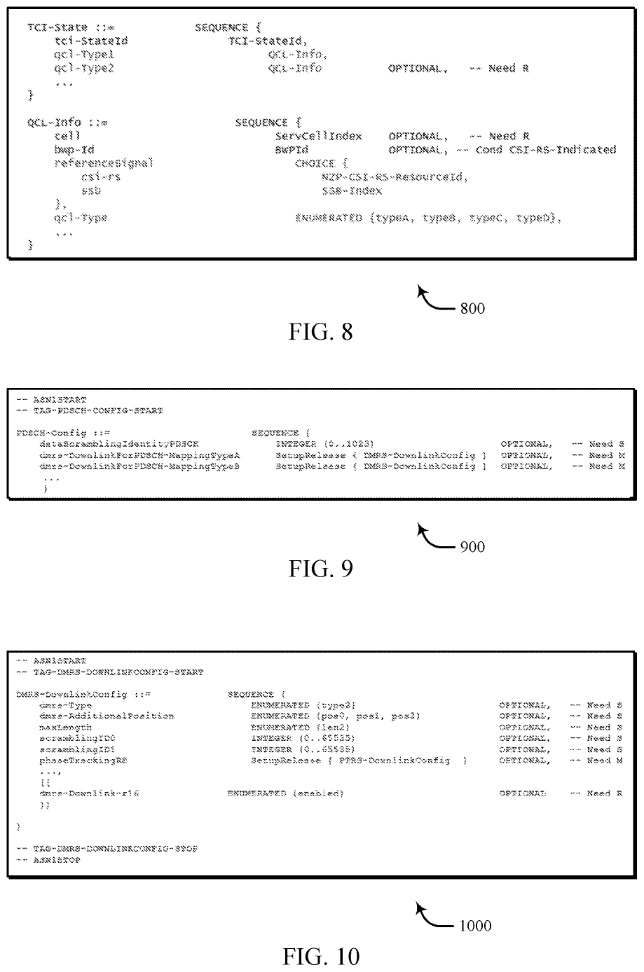

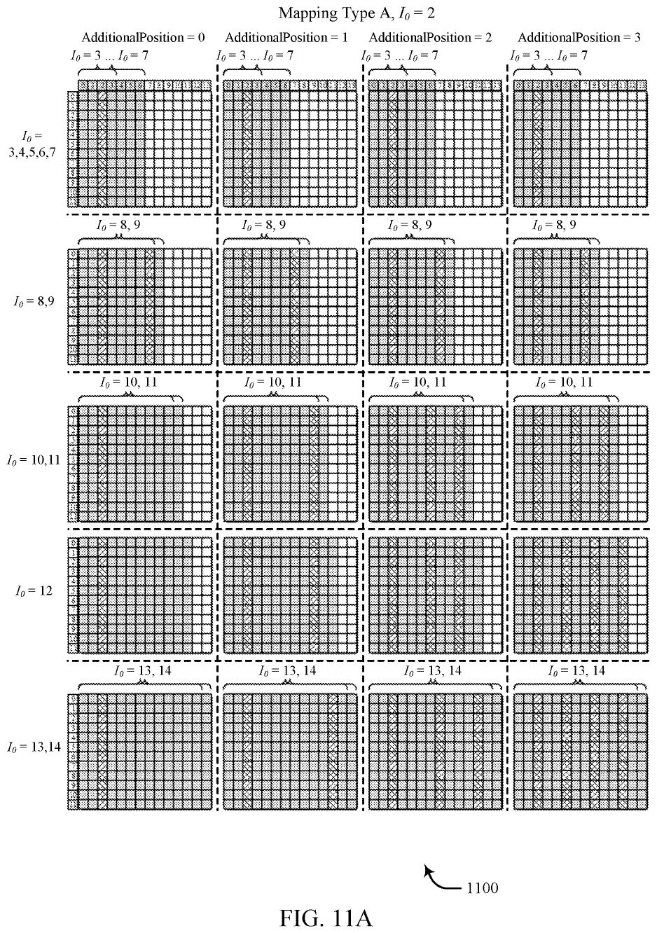

FIG. 10 illustrates an example 1000 of ASN-1 code for DMRS-DownlinkConfig, as related to reporting enhancements for mixed downlink transmissions in accordance with aspects of the present disclosure. In this example 1000, the IE DMRS-DownlinkConfig is used to configure downlink demodulation reference signals for PDSCH.

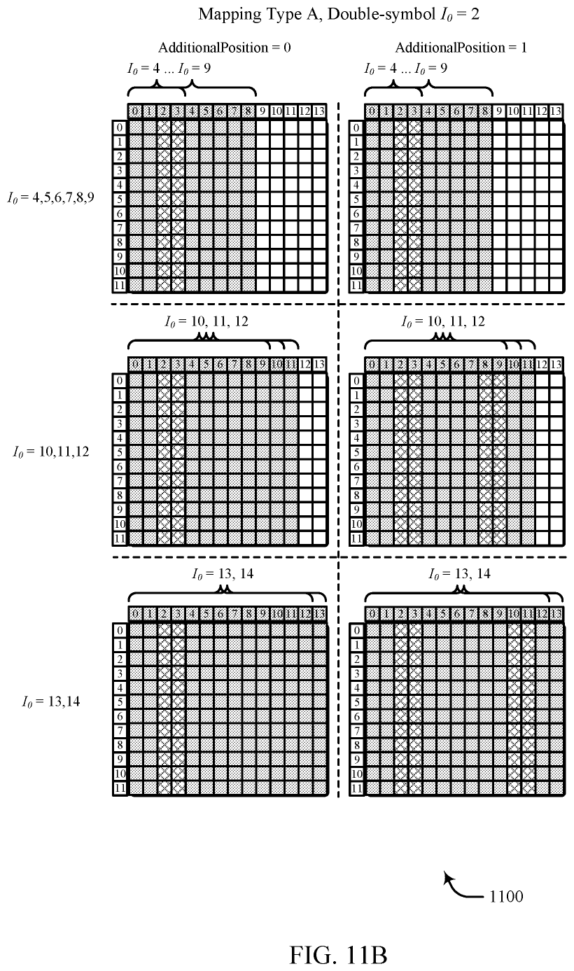

FIGS. 11A and 11B illustrate an example 1100 of DMRS patterns for mapping Type A with front-load DMRS, as related to reporting enhancements for mixed downlink transmissions in accordance with aspects of the present disclosure. In this example 1100, the time domain mapping of the DMRS patterns can be decomposed to two parts. For example the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to 4 DMRS symbols. The location of the DMRS is defined by both higher-layer configuration and dynamic (DCI-based) signaling, such as dmrs-TypeA-Position, maxLength, and dmrs-AdditionalPosition. When double-symbol DMRS is used, there can be up to one more double-symbol DMRS (total 4 DMRS symbols inside the PDSCH allocation). Different DMRS patterns for mapping Type A with front-load DMRS are shown in the example 1100.

In the absence of CSI-RS configuration, and unless otherwise configured, the UE may assume PDSCH DMRS and synchronization signal (SS)/physical broadcast channel (PBCH) block antenna ports are quasi co-located with respect to Doppler shift, Doppler spread, average delay, delay spread, and spatial Rx parameters (if applicable). However, a CSI-RS for tracking can be used as a QCL reference (e.g., having larger bandwidth than an SS/PBCH block). Furthermore, the UE may assume that the PDSCH DMRS within the same CDM group are quasi co-located with respect to Doppler shift, Doppler spread, average delay, delay spread, and spatial Rx. The UE may then perform a joint estimation of DMRS ports which are CDMed using the same long-term statistics, and it is not required to measure, or use, different long-term statistics for different DMRS ports of the same PDSCH.

With reference to codeword-to-layer mapping, the UE may assume that complex-valued modulation symbols for each of the codewords to be transmitted are mapped onto one or several layers according to Table 7. Complex-valued modulation symbols

$${d}^{( q )} ( 0 ) , … , {d}^{( q )} ( {M}_{symb}^{( q )} - 1 )$$

for codeword q may be mapped onto the layers

$$x ( i ) = {[ \begin{matrix}{x}^{( 0 )} ( i ) & … & {x}^{( v - 1 )} ( i )\end{matrix} ]}^{T} ,$$

$$i - 0 , 1 , … , {M}_{symb}^{layer} - 1$$

where ν is the number of layers and

$${M}_{symb}^{layer}$$

is the number of modulation symbols per layer.

TABLE 7
Codeword-to-layer mapping for spatial multiplexing.

| Number of layers | Number of codewords | Codeword-to-layer mapping $i = 0 , 1 , … , {M}_{symb}^{layer} - 1$ | |
|---|---|---|---|
| 1 | 1 | x⁽⁰⁾ (i) = d⁽⁰⁾ (i) | ${M}_{symb}^{layer} = {M}_{symb}^{( 0 )}$ |
| 2 | 1 | x⁽⁰⁾ (i) = d⁽⁰⁾ (2i) x⁽¹⁾ (i) = d⁽⁰⁾ (2i + 1) | ${M}_{symb}^{layer} = \frac{{M}_{symb}^{( 0 )}}{2}$ |
| 3 | 1 | x⁽⁰⁾ (i) = d⁽⁰⁾ (3i) x⁽¹⁾ (i) = d⁽⁰⁾ (3i + 1) | ${M}_{symb}^{layer} = \frac{{M}_{symb}^{( 0 )}}{3}$ |
| | | x⁽²⁾ (i) = d⁽⁰⁾ (3i + 2) | |
| 4 | 1 | x⁽⁰⁾ (i) = d⁽⁰⁾ (4i) x⁽¹⁾ (i) = d⁽⁰⁾ (4i + 1) | ${M}_{symb}^{layer} = \frac{{M}_{symb}^{( 0 )}}{4}$ |
| | | x⁽²⁾ (i) = d⁽⁰⁾ (4i + 2) | |
| | | x⁽³⁾ (i) = d⁽⁰⁾ (4i + 3) | |
| 5 | 2 | x⁽⁰⁾ (i) = d⁽⁰⁾ (2i) x⁽¹⁾ (i) = d⁽⁰⁾ (2i + 1) | ${M}_{symb}^{layer} = \frac{{M}_{symb}^{( 0 )}}{2} = \frac{{M}_{symb}^{( 1 )}}{3}$ |
| | | x⁽²⁾ (i) = d⁽⁰⁾ (3i) | |
| | | x⁽³⁾ (i) = d⁽¹⁾ (3i + 1) | |
| | | x⁽⁴⁾ (i) = d⁽¹⁾ (3i + 2) | |
| 6 | 2 | x⁽⁰⁾ (i) = d⁽⁰⁾ (3i) x⁽¹⁾ (i) = d⁽⁰⁾ (3i + 1) | ${M}_{symb}^{layer} = \frac{{M}_{symb}^{( 0 )}}{3} = \frac{{M}_{symb}^{( 1 )}}{3}$ |
| | | x⁽²⁾ (i) = d⁽⁰⁾ (3i + 2) | |
| | | x⁽³⁾ (i) = d⁽¹⁾ (3i) | |
| | | x⁽⁴⁾ (i) = d⁽¹⁾ (3i + 1) | |
| | | x⁽⁵⁾ (i) = d⁽¹⁾ (3i + 2) | |
| 7 | 2 | x⁽⁰⁾ (i) = d⁽⁰⁾ (3i) x⁽¹⁾ (i) = d⁽⁰⁾ (3i + 1) | ${M}_{symb}^{layer} = \frac{{M}_{symb}^{( 0 )}}{3} = \frac{{M}_{symb}^{( 1 )}}{4}$ |
| | | x⁽²⁾ (i) = d⁽⁰⁾ (3i + 2) | |
| | | x⁽³⁾ (i) = d⁽¹⁾ (4i) | |
| | | x⁽⁴⁾ (i) = d⁽¹⁾ (4i + 1) | |
| | | x⁽⁵⁾ (i) = d⁽¹⁾ (4i + 2) | |
| | | x⁽⁶⁾ (i) = d⁽¹⁾ (4i + 2) | |
| 8 | 2 | x⁽⁰⁾ (i) = d⁽⁰⁾ (4i) x⁽¹⁾ (i) = d⁽⁰⁾ (4i + 1) | ${M}_{symb}^{layer} = \frac{{M}_{symb}^{( 0 )}}{4} = \frac{{M}_{symb}^{( 1 )}}{4}$ |
| | | x⁽²⁾ (i) = d⁽⁰⁾ (4i + 2) | |
| | | x⁽³⁾ (i) = d⁽⁰⁾ (4i + 3) | |
| | | x⁽⁴⁾ (i) = d⁽¹⁾ (4i) | |
| | | x⁽⁵⁾ (i) = d⁽¹⁾ (4i + 1) | |
| | | x⁽⁶⁾ (i) = d⁽¹⁾ (4i + 2) | |
| | | x⁽⁷⁾ (i) = d⁽¹⁾ (4i + 3) | |

Aspects of reporting enhancements for mixed downlink transmissions include and/or are directed to antenna panels and/or ports, quasi-collocation, TCI state, and spatial relation. In implementations described herein, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel includes an array of antenna elements, where each antenna element is connected to hardware, such as a phase shifter that allows a control module to apply spatial parameters for transmission and/or reception of signals. The resulting radiation pattern is called a beam, which may or may not be unimodal and allows the device to amplify signals that are transmitted or received from spatial directions.

In one or more implementations, an antenna panel is virtualized as an antenna port in the specifications. An antenna panel can be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information is communicated via signaling or, in some implementations, capability information is provided to devices without a need for signaling. In the event that such information is available to other devices, it can be used for signaling or local decision making.

In one or more implementations, a device (e.g., a UE, a network node) antenna panel is a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel (or device panel) may be a logical entity with physical device antennas mapped to the logical entity. The mapping of physical device antennas to the logical entity can be based on device implementation. Communicating (e.g., receiving or transmitting) on at least a subset of antenna elements or antenna ports active for radiating energy (also referred to herein as active elements) of an antenna panel requires biasing or powering of the RF chain, which results in current drain or power consumption in the device associated with the antenna panel, including power amplifier and/or low noise amplifier power consumption associated with the antenna elements or antenna ports. The phrase “active for radiating energy,” as used herein is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, and depending on the particular device implementation, a device panel can have at least one of the following functionalities as an operational role: a unit of an antenna group to control its transmit beam independently, a unit of an antenna group to control its transmission power independently, and/or a unit of an antenna group to control its transmission timing independently. The device panel may be transparent to a gNB. For certain condition(s), a gNB or a network node can assume the mapping between the physical antennas of a device to the logical entity “device panel” may not be changed. For example, the condition may include until the next update or report from a device, or include a duration of time over which the gNB assumes there will be no change to the mapping. A device may report its capability with respect to the device panel to the gNB or network. The device capability can include at least the number of device panels. In an implementation, the device may support UL transmission from one beam within a panel, and with multiple panels, more than one beam (e.g., one beam per panel) may be used for UL transmission. In another implementation, more than one beam per panel may be supported or used for UL transmission.

In some described implementations, an antenna port is defined such that the channel over which a symbol on the antenna port is conveyed can be inferred from the channel over which another symbol on the same antenna port is conveyed. Two antenna ports are QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and/or spatial receive parameters. Two antenna ports may be quasi-located with respect to a subset of the large-scale properties, and a different subset of large-scale properties can be indicated by a QCL type. The QCL type can indicate which channel properties are the same between the two reference signals (e.g., on the two antenna ports). Thus, the reference signals can be linked to each other with respect to what the UE can assume about their channel statistics or QCL properties. For example, the QCL-type can be one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

Spatial receive parameters can include one or more of angle of arrival (AoA,) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same receive beamforming weights).

As described in this disclosure, an antenna port may be a logical port that corresponds to a beam (resulting from beamforming), or may correspond to a physical antenna on a device. In one or more implementations, a physical antenna can map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., a target RS of DMRS ports of the target transmission during a transmission occasion) and one or more source reference signals (e.g., SSB, CSI-RS, and/or sounding reference signal (SRS)) with respect to quasi co-location type parameters indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the described implementations, a TCI state includes at least one source RS to provide a reference (UE assumption) for determining QCL and/or a spatial filter.

In one or more implementations, spatial relation information associated with a target transmission can indicate parameters for configuring a spatial setting between the target transmission and a reference RS (e.g., SSB, CSI-RS, and/or SRS). For example, the device can transmit the target transmission with the same spatial domain filter used for reception of the reference RS (e.g., DL RS such as SSB or CSI-RS). In another example, the device may transmit the target transmission with the same spatial domain transmission filter used for the transmission of the reference RS (e.g., UL RS, such as SRS). A device can receive a configuration of multiple spatial relation information configurations for a serving cell for transmissions on the serving cell.

In some described implementations, an UL TCI state is provided if a device is configured with separate DL/UL TCI by RRC signaling. The UL TCI state can include a source reference signal which provides a reference for determining an UL spatial domain transmission filter for the UL transmission (e.g., dynamic-grant or configured-grant based PUSCH, dedicated PUCCH resources) in a CC, or across a set of configured CCs and/or BWPs.

In some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated physical downlink control channel (PDCCH) and/or PDSCH) and is used to determine UL spatial transmission filter (e.g., for UE-dedicated PUSCH and/or PUCCH) for a CC, or across a set of configured CCs and/or BWPs. In an example, the UL spatial transmission filter is derived from the RS of DL QCL Type-D in the joint TCI state. The spatial setting of the UL transmission may be according to the spatial relation with a reference to the source RS configured with qcl-Type set to “typed” in the joint TCI state.

In aspects of reporting enhancements for mixed downlink transmissions, the following notations are used interchangeably, including transmit-receive point (TRP), panel, set of antennas, set of antenna ports, uniform linear array, cell, node, radio head, communication (e.g., signals/channels) associated with a control resource set (CORESET), communication associated with a TCI state from a transmission configuration of at least two TCI states. The codebook type used for PMI reporting is arbitrary, and flexible in the use of different codebook types (e.g., Type-II Rel. 16 codebook, Type-II Rel. 17 codebook, Type-II Rel. 18 codebook, etc.). A TRS corresponds to an NZP-CSI-RS resource set with a parameter ‘trs-info’ being configured. A CSI-RS for beam management corresponds to an NZP-CSI-RS resource set with a parameter ‘repetition’ being configured. A CSI-RS for CSI corresponds to an NZP-CSI-RS resource set with neither parameters ‘trs-info’ nor ‘repetition’ being configured. A matrix implies a sequence of fields of an arbitrary dimension, including an array (vector) of values, a standard 2D matrix and more generally a Q-dimensional matrix (tensor), where Q≥2 and is an integer value. In examples, a mapping between a TB and a codeword transmitted in DL is based on a one-to-one mapping between the TBs and the codewords.

Aspects of the present disclosure include solutions for an indication of a CSI reporting setting corresponding to joint eMBB-based and URLLC-based DL transmissions (and/or other joint transmissions of two different types of TBs). In examples, a network configures a UE with CSI feedback corresponding to an eMBB-based DL transmission, a URLLC-based DL transmission, and/or a simultaneous transmission of an eMBB-based TB and a URLLC-based TB. In various examples, an indication for CSI information associated with such joint DL transmission includes one or more of the following implementations.

In an implementation, an RRC parameter is included in the CSI reporting setting. In an example, a higher-layer parameter (e.g., URLLC-mode) is included within the CSI-ReportConfig CSI Reporting Setting IE that configures the UE with CSI feedback reporting based on joint eMBB/URLLC channel reciprocity. In various examples, the higher-layer parameter may appear in various different sub-elements of the Reporting Setting IE.

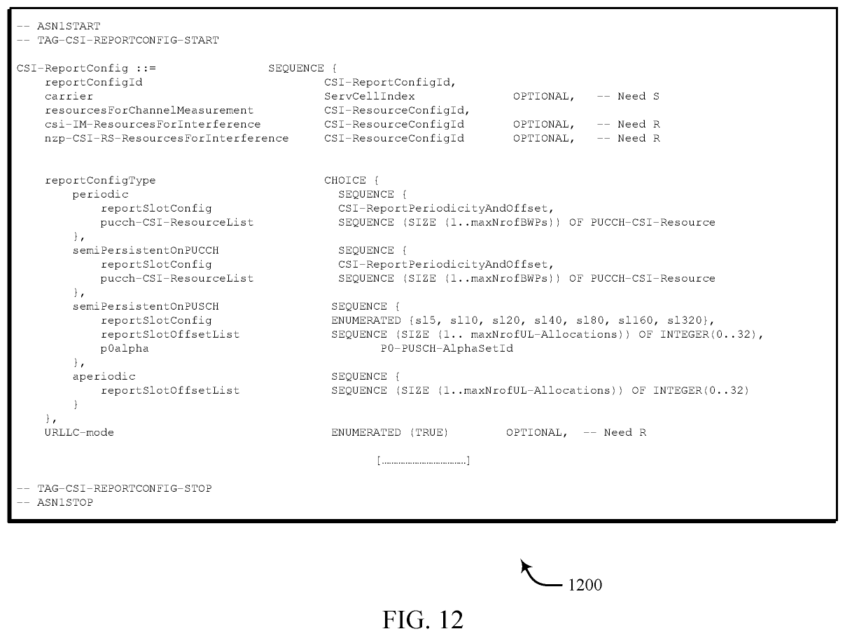

FIG. 12 illustrates an example 1200 of ASN-1 code for an implementation where an RRC parameter is included in the CSI reporting setting, as related to reporting enhancements for mixed downlink transmissions in accordance with aspects of the present disclosure. In this example 1200, the RRC parameter (“URLLC-mode”) is an example higher-layer parameter included within the CSI Reporting Setting IE that configures the UE (e.g. CSI ReportConfig).

In an implementation, an RRC parameter is included in the codebook configuration. In examples, a higher-layer parameter (e.g., URLLC-eMBB) is configured within the codebook configuration (CodebookConfig) IE (e.g., CodebookConfig-r16, CodebookConfig-r17, etc.). In an example, the new parameter (e.g., URLLC-eMBB) is a sub-parameter within a higher-layer parameter (e.g., codebookType), when the Codebook Type is set to ‘typeI-SinglePanel’.

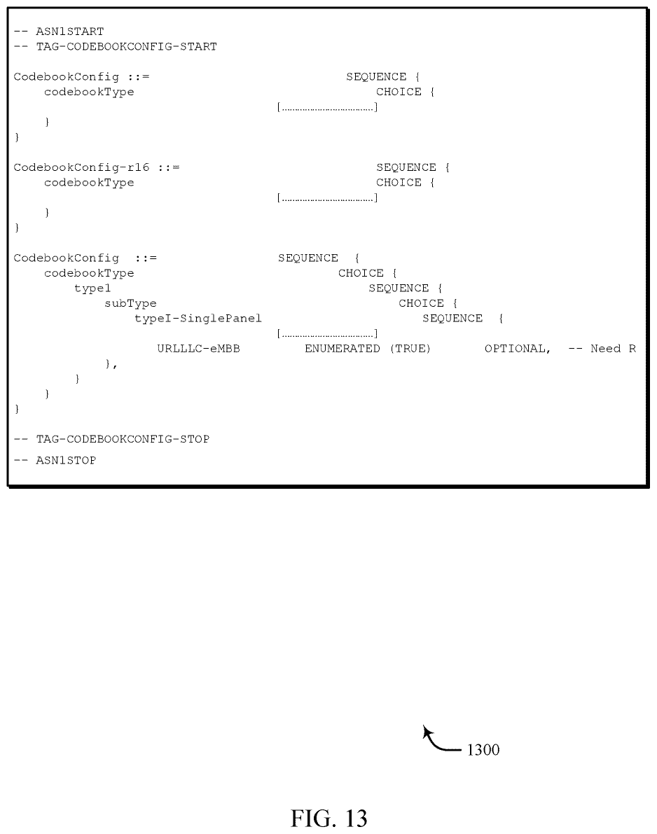

FIG. 13 illustrates an example 1300 of ASN-1 code for an implementation where an RRC parameter is included in the codebook configuration, as related to reporting enhancements for mixed downlink transmissions in accordance with aspects of the present disclosure. In this example 1300, the RRC parameter (“URLLC-eMBB”) is an example higher-layer parameter included within a codebook configuration ID (“CodebookConfig”) as a sub-parameter of the higher-layer parameter (codebookType) when the codebook type is set to ‘typeI-SinglePanel’).

In an implementation, a joint DL transmission is implicitly indicated via a selected CQI table index. In examples, a joint eMBB-based and URLLC-based DL transmission is indicated or inferred from a value of a higher-layer parameter corresponding to an index of a CQI table (e.g., cqi-Table) from a set of pre-configured CQI tables. In an example, a value of a first higher-layer parameter (e.g., cqi-Table) that corresponds to a codepoint mapped to two CQI tables indicates CSI reporting based on a joint eMBB-based and URLLC-based DL transmission. In an example, a second higher-layer parameter corresponding to a second CQI table (e.g., cqi-Table2) indicates CSI reporting based on the joint eMBB-based and URLLC-based DL transmission, if the second higher-layer parameter is configured, which is conditioned on configuring the first higher-layer parameter corresponding to the first CQI table. In an example, the two CQI tables (e.g., cqi-Table1 and cqi-Table2) correspond to different TB error probability thresholds (e.g., a first threshold associated with eMBB communications and a second threshold associated with URLLC communications, etc.).

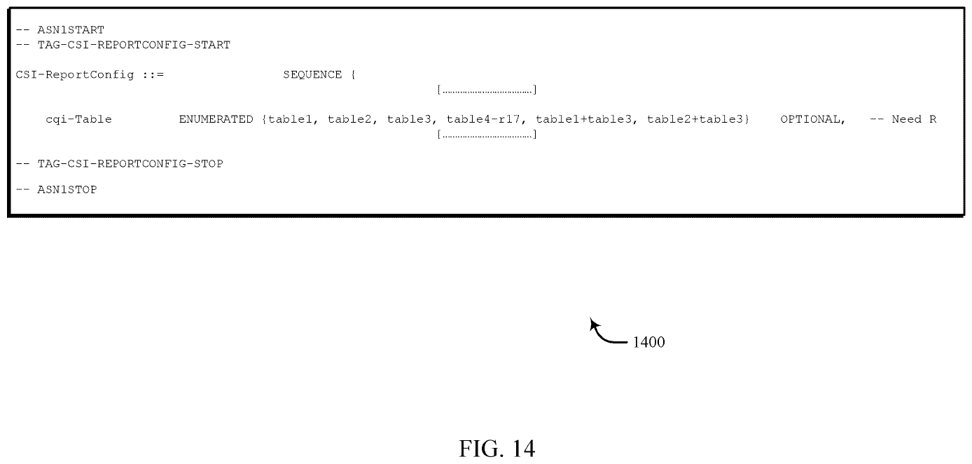

FIG. 14 illustrates an example 1400 of ASN-1 code for an implementation where a value of a first higher-layer parameter (e.g., cqi-Table) corresponds to a codepoint mapped to two CQI tables, as related to reporting enhancements for mixed downlink transmissions in accordance with aspects of the present disclosure. In this example 1300, the values table1+table3 and/or table2+table3 of the parameter cqi-Table) implicitly indicate joint DL transmissions (e.g., eMBB and URLLC, etc.).

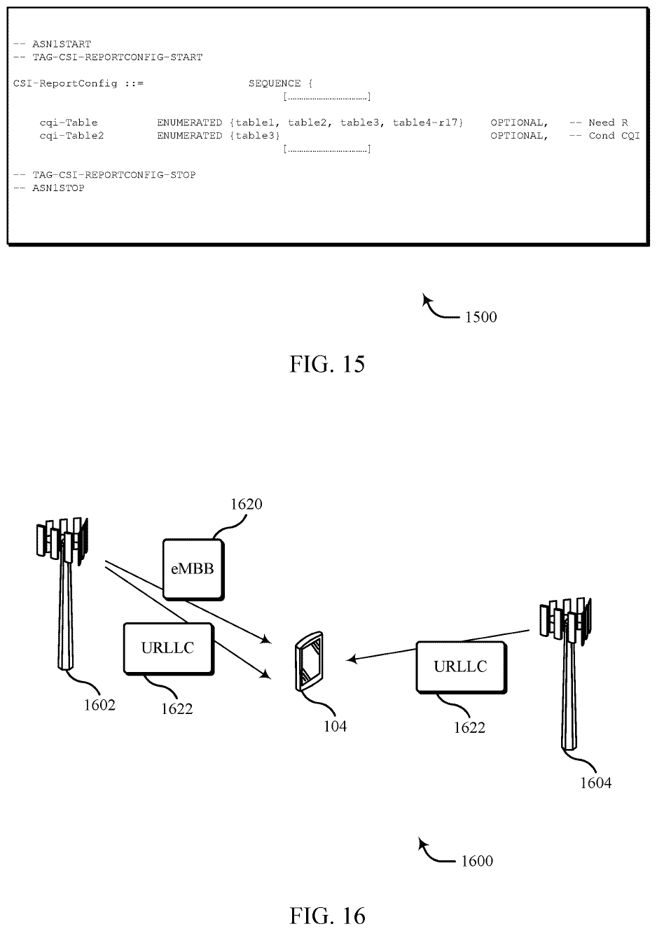

FIG. 15 illustrates an example 1500 of ASN-1 code for an implementation that includes a second higher-layer parameter to indicate a joint DL transmission, as related to reporting enhancements for mixed downlink transmissions in accordance with aspects of the present disclosure. In this example 1500, the system implicitly indicates a joint DL transmission by configuring the first higher-layer parameter (e.g., cqi-Table) and the second higher-layer parameter (e.g., cqi-Table2) as IEs in the CSI reporting setting (e.g., CSI-ReportConfig).

In an implementation, a joint DL transmission may be indicated via a repetition scheme. In examples, a parameter corresponding to a repetition scheme (e.g., RepetitionSchemeConfig) is configured to indicate a joint DL transmission (and/or other types of transmissions). In an example, a repetition scheme parameter is configured as part of a higher-layer configuration of the PDSCH, (e.g., the PDSCH configuration). In an example, the repetition scheme parameter is configured to a value corresponding to one or more of an FDM scheme, a TDM scheme or an SDM scheme. In an example, a CSI reporting setting that follows a repetition scheme parameter being configured in a PDSCH configuration corresponds to an indication of a joint eMBB-based and URLLC-based DL transmission.

In an implementation, corresponding CSI reports are fed back over different uplink channel types with different time-domain behaviors to indicate the different types of DL transmissions. In examples, a CSI report comprises one PMI carrying a set of precoding matrices corresponding to a set of one or more layers. In a first example, the CSI report is fed back over a PUSCH based on aperiodic CSI reporting. In a second example, the CSI report is fed back over PUSCH based on semi-persistent CSI reporting. In a third example, the CSI report is fed back over a PUCCH based on semi-persistent CSI reporting. In a fourth example, the CSI report is fed back over PUCCH based on periodic CSI reporting.

In an implementation, activation of a mixed codeword transmission over PDSCH configuration or via DCI triggering indicates a joint DL transmission. In examples, a parameter corresponding to a transmission of two transport blocks associated with two codewords is configured, where a first codeword is associated with eMBB-based DL transmission and a second codeword is associated with URLLC-based DL transmission. In a first example, the parameter is configured as part of a higher-layer configuration of the PDSCH (e.g., PDSCH configuration). In a second example, the parameter is configured as a subset of a field of the DCI corresponding to a PDSCH scheduling format (e.g., Format 1_1, Format 1_2). For instance, in this example, a subset of bits of a field in the DCI indicates whether two codewords corresponding to eMBB-based transmission and URLLC-based transmission are scheduled. In a third example, a DCI whose DCI format is associated with joint transmission of eMBB-based and URLLC-based TBs over two codewords is used for scheduling two PDSCH codewords. For instance, a first codeword is associated with eMBB-based DL transmission and a second codeword is associated with URLLC-based DL transmission.

In an implementation, a block error rate (BLER) and/or delay associated with a first TB (e.g., eMBB-based) is greater than a corresponding BLER or delay associated with a second TB (e.g., URLLC-based). In examples, eMBB-based DL transmission corresponds to a transmission of a first TB. For example, the first transport block is associated with at least one of a first maximum error probability threshold and/or a first maximum delay/latency threshold at which the first transport block is configured to be received by the UE. In this example, a URLLC-based DL transmission corresponds to a transmission of a second TB. The second TB is associated with at least one of a second maximum error probability threshold and/or a second maximum delay/latency threshold at which the second TB is configured to be received. In an example, a value of the first maximum error probability threshold is larger than the second maximum error probability threshold. In an example, a value of the first maximum delay/latency threshold is larger than or equal to a value of the second maximum delay/latency threshold. In an example, the value of the first maximum error probability threshold is 0.1, and the value of the second maximum error probability threshold is 0.00001. In an example, a ratio of the value of the first maximum error probability threshold to the value of the first maximum error probability threshold is 10^{x}, wherein x is a positive integer value (e.g., x=2).

Aspects of the present disclosure include solutions for transmission of one codeword from a same network node. Under this approach, one TB carrying one codeword is transmitted. For instance, in a scenario where there are two possible codeword types, a base station (e.g., TRP) is configured to transmit one codeword at a time to a UE. In examples, the codeword corresponds to one of an eMBB-based DL transmission and/or a URLLC-based transmission. In an example, a CSI report corresponding to the two candidate codewords is fed back by the UE to the network over a physical uplink channel. In examples, a UE configured with a CSI reporting setting associated with joint eMBB-based and URLLC-based DL transmission is also configured with a value of a report quantity comprising at least one of RI, PMI, and CQI quantities.

In an implementation, a UE is configured to include two RI values corresponding to two different codeword hypotheses in a CSI report. In examples, two RI values are included in the CSI report including a first RI value corresponding to an eMBB-based codeword and a second RI value corresponding to the URLLC-based codeword. In a first example, one codepoint of an RI value comprises a pair of RI values corresponding to the two codewords. In a second example, each RI value of the two RI values are reported using separate codepoints.

In an implementation, a first codeword associated with eMBB-based DL transmission is restricted with a maximum number of PDSCH layers (e.g., up to four PDSCH layers). In an implementation, a second codeword associated with URLLC-based DL transmission is restricted with a maximum number of PDSCH layers (e.g., up to two PDSCH layers).

In an implementation, two CQI values (e.g., corresponding to two different codeword hypotheses) are included in the CSI report, including a first CQI value corresponding to the eMBB-based codeword and a second CQI value corresponding to the URLLC-based codeword. In a first example, both CQI values follow a same CQI format (e.g., whether the reported CQI is in wideband format or sub-band format). In a second example, each of the two CQI values follow different CQI formats (e.g., the CQI corresponding to the eMBB-based codeword follows a sub-band format, and the CQI corresponding to the URLLC-based codeword follows a wideband format).

In an implementation, two PMI values (e.g., corresponding to two different codeword hypotheses) are included in the CSI report, including a first PMI value corresponding to the eMBB-based codeword and a second PMI value corresponding to the URLLC-based codeword. In a first example, a number of layers associated with the first PMI value is equivalent to the first RI value associated with the eMBB-based codeword, and a number of layers associated with the second PMI value is equivalent to the second RI value associated with the URLLC-based codeword. In a second example, the first PMI value corresponds to the first CQI value associated with the eMBB-based codeword, and second PMI value corresponds to the second CQI value associated with the URLLC-based codeword. In a third example, CSI parameters (e.g., RI, CQI, PMI) associated with the eMBB-based codeword are transmitted over a first of two CSI reports, and CSI parameters associated with the URLLC-based codeword are transmitted over a second of the two CSI reports.

In an implementation, a common PMI is used for two codewords (e.g., each corresponding to a subset of layers of the PMI). For example, consider a PMI having four layers. In this example, for an eMBB transmission, all four layers are used whereas for a URLLC transmission only two of the layers are used (e.g., layers 2, 4). Thus, in this example, the present disclosure provides for indicating layer indices of the two selected layers. More generally, in examples, one PMI value is included in the CSI report. For instance, a first subset of vectors of the PMI value corresponds to an eMBB-based codeword, and a second subset of vectors of the PMI value correspond to the URLLC-based codeword. In a first example, the first subset of vectors of the PMI value comprises all the vectors of the PMI value. In a second example, a number of layers corresponding to the first subset of vectors of the PMI value is equal to the first RI value associated with the eMBB-based codeword, and a number of layers corresponding to the second subset of vectors of the PMI value is equal to the second RI value associated with the URLLC-based codeword. In a third example, the first subset of vectors of the PMI value corresponds to the first CQI value associated with the eMBB-based codeword, and the second subset of vectors of the PMI value corresponds to the second CQI value associated with the URLLC-based codeword.

In an implementation, a parameter is provided to indicate a subset of layers per codeword type. In examples, layer indices of at least one of a first subset of the layers of the PMI and a second subset of the layers of the PMI are reported in the CSI report. In a first example, the layer indices are reported as a bitmap whose number of entries is equal to a number of layers of the PMI. In the first example, a number of ones in the bitmap is equal to the respective RI value (e.g., a first RI value associated with an eMBB-based codeword or a second RI value associated with a URLLC-based codeword). In a second example, the layer indices are reported as a joint parameter based on a combinatorial value. For instance, in a scenario where a total number of layers of the PMI is R, and the first and second RI values are R1, R2, respectively, the indication is in a form of

$$⌈ {log}_{2} {C}_{{R}_{2}}^{R} ⌉ bits ,$$

wherein

$${C}_{b}^{a}$$

is a combinatorial function that takes on values as shown in Table 8. In a third example, only layer indices of the second subset of layers of the PMI are reported.

TABLE 8
Values of combinatorial function C_{b}^{a}, where b ≤ a

| | b = 1 | b = 2 | b = 3 | b = 4 | b = 5 | b = 6 | b = 7 | b = 8 |
|---|---|---|---|---|---|---|---|---|
| a = 1 | 1 | | | | | | | |
| a = 2 | 2 | 1 | | | | | | |
| a = 3 | 3 | 3 | 1 | | | | | |
| a = 4 | 4 | 6 | 4 | 1 | | | | |
| a = 5 | 5 | 10 | 10 | 5 | 1 | | | |
| a = 6 | 6 | 15 | 20 | 15 | 6 | 1 | | |
| a = 7 | 7 | 21 | 35 | 35 | 21 | 7 | 1 | |
| a = 8 | 8 | 28 | 56 | 70 | 56 | 28 | 8 | 1 |

In an implementation, a layer indicator (LI) parameter (e.g., legacy LI parameter) is used to indicate eMBB layers. In examples, a LI value is reported in the CSI report, where the LI value corresponds to a strongest layer of one of the eMBB-based codeword, the URLLC-based codeword, or both. In an example, the LI value indicates a layer index corresponding to the URLLC-based codeword.

In an implementation, a given CSI-RS port group includes a channel measurement resource (CMR) quasi-co-located with a DMRS group. In examples, a single NZP-CSI-RS resource for channel measurement is associated with DMRS ports. The NZP-CSI-RS resource includes two groups of CSI-RS ports. In a first example, each of the two groups of CSI-RS ports is associated with a distinct CDM group, or alternatively a distinct set of CDM groups. In a second example, a first group of CSI-RS ports is QCLed with a first DMRS port group (e.g., with respect to Type-A and Type-D if applicable), and a second group of CSI-RS ports is QCLed with a second DMRS port group (e.g., with respect to Type-A and Type-D if applicable). In a third example, a first group of CSI-RS ports is QCLed with the first DMRS port group (e.g., with respect to Type-A and Type-D if applicable), and both the first group of CSI-RS ports and a second group of CSI-RS ports are QCLed the second DMRS port group (e.g., with respect to Type-A and Type-D if applicable).

Aspects of the present disclosure include solutions for up to two codeword transmissions from a same network node. Under this approach, up to two TBs carrying up to two codewords are transmitted. In examples, the up to two codewords correspond to at least one of eMBB-based DL transmission and URLLC-based transmission (e.g., eMBB only, URLLC only, or both eMBB and URLLC codewords simultaneously transmitted). In examples, a CSI report corresponding to the up to two codewords is fed back by the UE to the network over a physical uplink channel. In examples, a UE configured with a CSI reporting setting associated with joint eMBB-based and URLLC-based DL transmission is also configured with a value of a report quantity comprising at least one of RI, PMI, and CQI quantities.

In an implementation, up to four RI values are included in the CSI report, including: a first RI value (e.g., RI=4) corresponding to one codeword transmission associated with an eMBB-based codeword, a second RI value (e.g., RI=3) corresponding to one codeword transmission associated with a URLLC-based codeword, a third RI value (e.g., RI=2) corresponding to the eMBB-based codeword in a concurrent two codeword transmission, and a fourth RI value (e.g., RI=1) corresponding to the URLLC-based codeword in a concurrent two codeword transmission. In an example, one codepoint of an RI value comprises a pair of RI values corresponding to the third RI value and the fourth RI value assuming a concurrent two codeword transmission.

In an implementation, a set of layer pairs (e.g., eMBB/URLLC layer pairs) associated with the two codewords comprises {(1,1), (1,2), (1,3), (1,4), (2,1), (2,2), (2,3), (2,4)}, wherein a first value of the layer pair corresponds to a number of layers of the first codeword associated with eMBB-based DL transmission, and a second value of the layer pair corresponds to a number of layers of the second codeword associated with URLLC-based DL transmission.

In an implementation, up to four CQI values (e.g., corresponding to eMBB only, URLLC only, eMBB for mixed codewords, and/or URLLC for mixed codewords) are included in the CSI report. The up to four CQI values include: a first CQI value corresponding to one codeword transmission associated with the eMBB-based codeword, a second CQI value corresponding to one codeword transmission associated with the URLLC-based codeword, a third CQI value corresponding to the eMBB-based codeword assuming two concurrent codeword transmissions, and a fourth CQI value corresponding to the URLLC-based codeword assuming two concurrent codeword transmissions. In a first example, the up to four CQI values follow a same CQI format (e.g., whether the reported CQI is in wideband format or sub-band format). In a second example, the first CQI value and the second CQI value follow a first CQI format (e.g., wideband format), whereas the third CQI value and the fourth CQI value follow a second CQI format (e.g., sub-band format).

In an implementation, two PMI values are included in the CSI report. In examples, the two PMI values include a first PMI value corresponding to the eMBB-based codeword and a second PMI value corresponding to the URLLC-based codeword. In a first example, a number of layers associated with the first PMI value is equivalent to the first RI value associated with the eMBB-based codeword, and a number of layers associated with the second PMI value is equivalent to the second RI value associated with the URLLC-based codeword. In a second example, the first PMI value corresponds to the first CQI value associated with the eMBB-based codeword, and second PMI value corresponds to the second CQI value associated with the URLLC-based codeword.

In an implementation, the PMIs of mixed codewords correspond to subsets of both PMIs. In examples, the first PMI value comprises a first subset of vectors of the first PMI value corresponding to the eMBB-based codeword assuming two concurrent codeword transmissions, and the second PMI value comprises a second subset of vectors of the second PMI value corresponding to the URLLC-based codeword assuming two concurrent codeword transmissions (e.g., PMI_1 for standalone eMBB transmission, PMI_2 for standalone URLLC transmission, subset_1 of PMI_1 for eMBB codeword in a joint eMBB/URLLC transmission, subset_2 of PMI_2 for URLLC codeword in the joint eMBB/URLLC transmission). In a first example, the first subset of vectors of the first PMI value comprises all the vectors of the first PMI value. In a second example, the second subset of vectors of the second PMI value comprises all the vectors of the second PMI value. In a third example, a number of layers corresponding to the first subset of vectors of the first PMI value is equal to the third RI value associated with the eMBB-based codeword assuming two concurrent codeword transmissions, and a number of layers corresponding to the second subset of vectors of the second PMI value is equal to the fourth RI value associated with the URLLC-based codeword assuming two concurrent codeword transmissions. In a fourth example, a number of layers corresponding to the first subset of vectors of the first PMI value is equal to the third CQI value associated with the eMBB-based codeword assuming two concurrent codeword transmissions, and a number of layers corresponding to the second subset of vectors of the second PMI value is equal to the fourth CQI value associated with the URLLC-based codeword assuming two concurrent codeword transmissions.

In an implementation, a parameter is configured to indicate a subset of layers of the PMI for each codeword time. In examples, layer indices of at least one of a first subset of layers of a first PMI and a second subset of layers of a second PMI are reported in the CSI report. In a first example, the layer indices are reported in a form of a bitmap whose number of entries is equal to a number of layers of the PMI, and where a number of ones in the bitmap is equal to the respective RI value (e.g., the first RI value associated with the eMBB-based codeword or the second RI value associated with the URLLC-based codeword). In a second example, the layer indices are reported in a form of a joint parameter based on a combinatorial value. For instance, assuming the total number of layers of the PMI is R, and the first and second RI values are R1, R2, respectively, the indication is in a form of

$$⌈ {log}_{2} {C}_{{R}_{2}}^{R} ⌉ bits ,$$

wherein

$${C}_{b}^{a}$$

is a combinatorial function that takes on values as shown in Table 8.

In an implementation, up to two LI values are reported in the CSI report values. In an example, the up to two LI values a first LI value corresponds to a strongest layer of the eMBB-based codebook (e.g., a legacy LI parameter, etc.), and a second LI value corresponds to a strongest layer of the URLLC-based codebook.

In an implementation, a single NZP-CSI-RS resource for channel measurement is associated with the DMRS ports. The NZP-CSI-RS resource further includes two groups of CSI-RS ports. In a first example, each of the two groups of CSI-RS ports is associated with a distinct CDM group, or alternatively a distinct set of CDM groups. In a second example, a first group of CSI-RS ports is QCLed with the first DMRS port group (e.g., with respect to Type-A and Type-D if applicable), and a second group of CSI-RS ports is QCLed with the second DMRS port group (e.g., with respect to Type-A and Type-D if applicable). In a third example, a first group of CSI-RS ports is QCLed with the first DMRS port group (e.g., with respect to Type-A and Type-D if applicable), whereas both the first group of CSI-RS ports and a second group of CSI-RS ports are associated with the second DMRS port group (e.g., with respect to Type-A and Type-D if applicable).

In an implementation, the UE generates a distinct CSI report for each of the eMBB-based DL transmission, URLLC-based transmission, and the joint eMBB-based and URLLC-based transmission. In an example, a CSI report corresponding to one transmission type comprises at least one RI value, at least one CQI value and at least one PMI value associated with the one transmission type.

Aspects of the present disclosure include solutions for up to two codeword transmissions from two network nodes. Under this approach, in examples, a codeword corresponding to a URLLC-based transmission is transmitted from up to two network nodes (e.g., network entities, base stations, etc.). In an example, the network performs a one-to-one mapping of layers to DMRS ports. In an example, URLLC layers (e.g., transmitted from two nodes) are associated (e.g., QCLed) with two CSI-RS resources (e.g., each CSI-RS resource corresponding to a distinct node). In an example, eMBB layers (e.g., transmitted from one node) are associated (e.g., QCLed) with a first CSI-RS resource.

FIG. 16 illustrates an example of a wireless communication system 1600 in which two transmission reception points (TRPs) 1602 and 1604 are transmitting an eMBB-based codeword 1620 and a URLLC-based codeword 1622 to a UE 104, as related to reporting enhancements for mixed downlink transmissions in accordance with aspects of the present disclosure.

In an implementation, a URLLC codeword is transmitted over two different sets of time and/or frequency resources (e.g., FDM, TDM). In examples, a URLLC-based codeword is transmitted over the PDSCH over two sets of time/frequency resource pairs. For instance, the two sets of time/frequency resource pairs include a first set of time/frequency resource pairs associated with a first of the two network nodes, and a second set of time/frequency resource pairs associated with a second of the two network nodes. In a first example, the first set of time/frequency resource pairs corresponds to a first half of physical resource blocks of a bandwidth part, and the second set of time/frequency resource pairs corresponds to a second half of physical resource blocks of a bandwidth part (e.g., similar to FDM scheme A). In a second example, the first set of time/frequency resource pairs corresponds to a first group of symbols of a slot, and the second set of time/frequency resource pairs corresponds to a second group of symbols of the slot (e.g., similar to TDM scheme A).

In an implementation, a URLLC codeword corresponds to two PMI values from two different TRPs. In examples, up to two PMI values are associated with a same codeword corresponding to URLLC-based transmission. A first of the two PMI values is associated with a first set of time/frequency resource pairs, and a second of the two PMI values is associated with a second set of time/frequency resource pairs. In a first example, at least one of a common RI value, a common CQI value and a common LI value are associated with the two PMI values.

In an implementation, up to two PMI values are associated with two distinct NZP-CSI-RS resources for channel measurement (e.g., two CMRs). In a first example, the two NZP-CSI-RS resources are associated with a same NZP-CSI-RS resource set.

In an implementation, a set of PDSCH-based DMRS ports includes two groups of PDSCH-based DMRS ports. The two groups of PDSCH-based DMRS ports include a first group of PDSCH-based DMRS ports associated with an eMBB-based codeword and a second group of PDSCH-based DMRS ports associated with a URLLC-based codeword. In a first example, the two groups of PDSCH-based DMRS ports are associated with two CDM groups. In a second example, a number of PDSCH-based DMRS ports of the first group is equal to a number of layers of the eMBB-based codeword, and a number of PDSCH-based DMRS ports of the second group is equal to a number of layers of the URLLC-based codeword.

In an implementation, the two NZP-CSI-RS resources for channel measurement are associated with the two groups of DMRS ports. In a first example, a first CSI-RS resource is QCLed with the first DMRS port group (e.g., with respect to Type-A and Type-D if applicable), whereas the first CSI-RS resources and a second CSI-RS resources are QCLed with the second DMRS port group (e.g., with respect to Type-A and Type-D if applicable). In a second example, the first CSI-RS resource is further decomposed into two CSI-RS port groups. In this example, the first CSI-RS port group of the first CSI-RS resource is QCLed with the first DMRS port group (e.g., with respect to Type-A and Type-D if applicable), whereas both CSI-RS port groups of the first CSI-RS resource and the second CSI-RS resource are associated with the second DMRS port group (e.g., with respect to Type-A and Type-D if applicable). In a third example, the first CSI-RS resource and the second CSI-RS resource are associated with first and second network nodes (e.g., two TRPs). In this example, the first network node is associated with transmission of both the eMBB-based codeword and the URLLC-based codeword, and the second network node is associated with transmission of the URLLC-based codeword.

Aspects of the present disclosure include solutions for further aspects of joint eMBB/URLLC-based DL transmission. In examples, two TBs carrying up to two codewords are transmitted. In an example, the up to two codewords correspond to at least one of eMBB-based DL transmission and URLLC-based transmission.

In an implementation, a joint eMBB/URLLC-based CSI reporting setting has a highest priority compared to other CSI settings, and thus overrides previously received reporting settings at a UE. In examples, a CSI reporting setting that schedules the UE with aperiodic reporting of a CSI report comprising CSI associated with at least one CSI report quantity associated with URLLC-based codeword transmission is expected to override, null out, and/or replace one or more other CSI reporting settings received at the UE prior to the CSI reporting setting.

In an implementation, if a UE is configured with a joint eMBB/URLLC-based CSI reporting setting, the network is configured to delay sending further CSI reporting settings at least until a corresponding CSI report is transmitted from the UE. In examples, a number of CPUs, or simultaneous CSI reports per CC, is expected to take on a maximum value corresponding to a CSI reporting setting that schedules the UE with aperiodic reporting of a CSI report comprising CSI associated with at least one CSI report quantity associated with URLLC-based codeword transmission.

In an implementation, A type-I PMI codebook is used for joint eMBB/URLLC-based CSI reporting. In examples, a CSI reporting setting that schedules the UE with aperiodic reporting of a CSI report comprising CSI associated with at least one CSI report quantity associated with URLLC-based codeword transmission, is also to configure the UE with a codebook configuration corresponding to only a Type-I single-panel codebook.

In an implementation, for the purpose of CSI processing of a number of supported simultaneous CSI calculations, if a CSI-RS resource is referred N times by one or more CSI Reporting Settings, the CSI-RS resource and the CSI-RS ports within the CSI-RS resource are counted N times, except if the same CSI-RS resource is referred two times under a same CSI reporting setting corresponding to a CSI report comprising CSI for URLLC-based codeword reception and eMBB-based codeword reception (e.g., in which case the CSI-RS resource and the CSI-RS ports within the CSI-RS resource are counted one time).

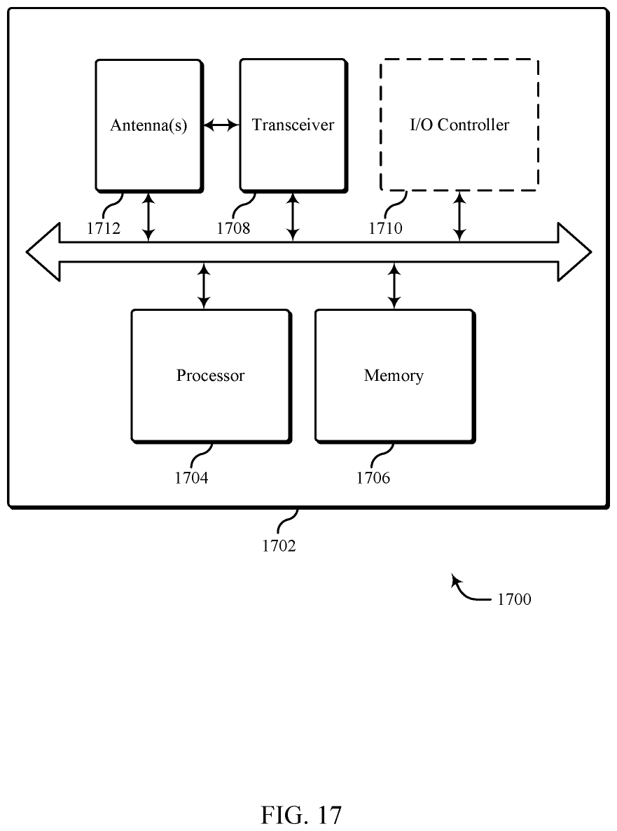

FIG. 17 illustrates an example of a block diagram 1700 of a device 1702 that supports reporting enhancements for mixed downlink transmissions in accordance with aspects of the present disclosure. The device 1702 may be an example of a UE 104 as described herein. The device 1702 may support wireless communication with one or more network entities 102, UEs 104, or any combination thereof. The device 1702 may include components for bi-directional communications including components for transmitting and receiving communications, such as a processor 1704, a memory 1706, a transceiver 1708, and an I/O controller 1710. These components may be in electronic communication or otherwise coupled (e.g., operatively, communicatively, functionally, electronically, electrically) via one or more interfaces (e.g., buses).

The processor 1704, the memory 1706, the transceiver 1708, or various combinations thereof or various components thereof may be examples of means for performing various aspects of the present disclosure as described herein. For example, the processor 1704, the memory 1706, the transceiver 1708, or various combinations or components thereof may support a method for performing one or more of the operations described herein.

In some implementations, the processor 1704, the memory 1706, the transceiver 1708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1704 and the memory 1706 coupled with the processor 1704 may be configured to perform one or more of the functions described herein (e.g., executing, by the processor 1704, instructions stored in the memory 1706).

For example, the processor 1704 may support wireless communication at the device 1702 in accordance with examples as disclosed herein. The processor 1704 may be configured as or otherwise support a means for receiving, from at least one network entity, a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB; generating, based at least in part on the CSI reporting setting, a CSI report corresponding to at least one of the plurality of communication modes; and transmitting a second signaling as the CSI report to the at least one network entity over a physical uplink channel.

Additionally, the processor 1704 may be configured as or otherwise support any one or combination of the first TB is associated with a first TB error probability threshold and the second TB is associated with a second TB error probability threshold. The first TB error probability threshold is higher than the second TB error probability threshold. The first TB is associated with a first latency threshold and the second TB is associated with a second latency threshold. Receiving one or more DL-RS based on the CSI reporting setting. The CSI configuration is indicated by at least one of: a higher-layer configuration parameter in the CSI reporting setting; a higher-layer configuration parameter in a codebook configuration associated with the CSI reporting setting; a selection of at least two CQI tables associated with different TB error probability thresholds; or a repetition scheme configuration parameter of a received PDSCH configuration, the repetition scheme configuration parameter associated with time-division multiplexing, frequency-division multiplexing, or spatial-division multiplexing. the physical uplink channel includes at least one of: a PUSCH based on at least one of an aperiodic time-domain behavior reporting configuration or a semi-persistent time-domain behavior reporting configuration; or a PUCCH based on at least one of a periodic time-domain behavior reporting configuration or a semi-persistent time-domain behavior reporting configuration. The CSI reporting setting includes an indication of a report quantity including at least one of a RI, a PMI, or a CQI. The CSI report includes a first pair of values associated with the first communication mode and a second pair of values associated with the second communication mode, the first pair of values including a first RI and a first CQI, the second pair of values including a second RI and a second CQI. The CSI report includes a first PMI corresponding to the first communication mode and a second PMI corresponding to the second communication mode. The CSI report includes a PMI corresponding to the first communication mode and the second communication mode. A first subset of layers of the PMI is associated with the first communication mode. A second subset of layers of the PMI is associated with the second communication mode. The CSI report includes a parameter indicating layer indices of at least one of the first subset of layers or the second subset of layers.

Additionally, the CSI report includes one or more pairs of values, each of the one or more pairs of values including a RI and a CQI. The one or more pairs of values include: a first pair of values associated with the first communication mode; a second pair of values associated with the second communication mode; a third pair of values associated with a first of two codewords corresponding to the third communication mode; and a fourth pair of values associated with a second of the two codewords corresponding to the third communication mode. The CSI report includes a first PMI associated with the first communication mode and a second PMI associated with the second communication mode. A first subset of layers of the first PMI is associated with a first codeword corresponding to the third communication mode. A second subset of layers of the second PMI is associated with the second codeword corresponding to the third communication mode. The CSI report includes a parameter indicating layer indices of at least one of the first subset of layers or the second subset of layers. the CSI report includes: a first layer indicator indicating a first layer index corresponding to the first subset of the layers; and a second layer indicator indicating a second layer index corresponding to the second subset of layers. A codeword corresponding to the second TB is transmitted over the PDSCH using a first set of resources associated with a first network entity and a second set of resources associated with a second network entity. The first set of resources includes time resources, frequency resources, or a pair of time and frequency resources. The second set of resources includes time resources, frequency resources, or a pair of time and frequency resources. The first communication mode corresponds to a mobile broadband communication mode. The second communication mode corresponds to at least one of a high reliability communication mode or a low latency communication mode. A codeword corresponding to the second TB is associated with two NZP-CSI-RS resources for channel measurement.

Additionally, a codeword corresponding to the second TB is associated with a DMRS that includes a first group of DMRS ports and a second group of DMRS ports. The first group of DMRS ports is quasi-co-located with a first NZP-CSI-RS resource. The second group of the DMRS ports is quasi-co-located with a second NZP-CSI-RS resource. The CSI reporting setting is configured to override one or more other CSI reporting settings received by the apparatus prior to receipt of the CSI reporting setting. A number of CSI processing units (CPUs) associated with the CSI reporting setting corresponds to a maximum number of CPUs available at the apparatus. Generating, based at least in part on the CSI reporting setting, at least one of a first CSI report corresponding the first communication mode, a second CSI report corresponding to the second communication mode, and a third CSI report corresponding to the third communication mode. Each of the at least one of the first CSI report, the second CSI report, and the third CSI report includes at least one of a RI, a PMI, or a CQI.

Additionally, or alternatively, the device 1702, in accordance with examples as disclosed herein, may include a processor; and a memory coupled with the processor, the processor configured to cause the apparatus to: receive, from at least one network entity, a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB; generate, based at least in part on the CSI reporting setting, a CSI report corresponding to at least one of the plurality of communication modes; and transmit a second signaling as the CSI report to the at least one network entity over a physical uplink channel.

Additionally, the wireless communication at the device 1702 may include any one or combination of the first TB is associated with a first TB error probability threshold and the second TB is associated with a second TB error probability threshold. The first TB error probability threshold is higher than the second TB error probability threshold. The first TB is associated with a first latency threshold and the second TB is associated with a second latency threshold. The processor configured to cause the apparatus to one or more DL-RS based on the CSI reporting setting. The CSI configuration is indicated by at least one of: a higher-layer configuration parameter in the CSI reporting setting; a higher-layer configuration parameter in a codebook configuration associated with the CSI reporting setting; a selection of at least two CQI tables associated with different TB error probability thresholds; or a repetition scheme configuration parameter of a received PDSCH configuration, the repetition scheme configuration parameter associated with time-division multiplexing, frequency-division multiplexing, or spatial-division multiplexing. the physical uplink channel includes at least one of: a PUSCH based on at least one of an aperiodic time-domain behavior reporting configuration or a semi-persistent time-domain behavior reporting configuration; or a PUCCH based on at least one of a periodic time-domain behavior reporting configuration or a semi-persistent time-domain behavior reporting configuration. The CSI reporting setting includes an indication of a report quantity including at least one of a RI, a PMI, or a CQI. The CSI report includes a first pair of values associated with the first communication mode and a second pair of values associated with the second communication mode, the first pair of values including a first RI and a first CQI, the second pair of values including a second RI and a second CQI. The CSI report includes a first PMI corresponding to the first communication mode and a second PMI corresponding to the second communication mode. The CSI report includes a PMI corresponding to the first communication mode and the second communication mode. A first subset of layers of the PMI is associated with the first communication mode. A second subset of layers of the PMI is associated with the second communication mode. The CSI report includes a parameter indicating layer indices of at least one of the first subset of layers or the second subset of layers.

Additionally, the CSI report includes one or more pairs of values, each of the one or more pairs of values including a RI and a CQI. The one or more pairs of values include: a first pair of values associated with the first communication mode; a second pair of values associated with the second communication mode; a third pair of values associated with a first of two codewords corresponding to the third communication mode; and a fourth pair of values associated with a second of the two codewords corresponding to the third communication mode. The CSI report includes a first PMI associated with the first communication mode and a second PMI associated with the second communication mode. A first subset of layers of the first PMI is associated with a first codeword corresponding to the third communication mode. A second subset of layers of the second PMI is associated with the second codeword corresponding to the third communication mode. The CSI report includes a parameter indicating layer indices of at least one of the first subset of layers or the second subset of layers. the CSI report includes: a first layer indicator indicating a first layer index corresponding to the first subset of the layers; and a second layer indicator indicating a second layer index corresponding to the second subset of layers. A codeword corresponding to the second TB is transmitted over the PDSCH using a first set of resources associated with a first network entity and a second set of resources associated with a second network entity. The first set of resources includes time resources, frequency resources, or a pair of time and frequency resources. The second set of resources includes time resources, frequency resources, or a pair of time and frequency resources. The first communication mode corresponds to a mobile broadband communication mode. The second communication mode corresponds to at least one of a high reliability communication mode or a low latency communication mode. A codeword corresponding to the second TB is associated with two NZP-CSI-RS resources for channel measurement.

Additionally, a codeword corresponding to the second TB is associated with a DMRS that includes a first group of DMRS ports and a second group of DMRS ports. The first group of DMRS ports is quasi-co-located with a first NZP-CSI-RS resource. The second group of the DMRS ports is quasi-co-located with a second NZP-CSI-RS resource. The CSI reporting setting is configured to override one or more other CSI reporting settings received by the apparatus prior to receipt of the CSI reporting setting. A number of CSI processing units (CPUs) associated with the CSI reporting setting corresponds to a maximum number of CPUs available at the apparatus. The processor configured to cause the apparatus to generate, based at least in part on the CSI reporting setting, at least one of a first CSI report corresponding the first communication mode, a second CSI report corresponding to the second communication mode, and a third CSI report corresponding to the third communication mode. Each of the at least one of the first CSI report, the second CSI report, and the third CSI report includes at least one of a RI, a PMI, or a CQI.

The processor 1704 of the device 1702, such as a UE 104, may support wireless communication in accordance with examples as disclosed herein. The processor 1704 includes at least one controller coupled with at least one memory, and is configured to or operable to cause the processor to receive, from at least one network entity, a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB; generate, based at least in part on the CSI reporting setting, a CSI report corresponding to at least one of the plurality of communication modes; and transmit a second signaling as the CSI report to the at least one network entity over a physical uplink channel.

The processor 1704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1704 may be configured to operate a memory array using a memory controller. In some other implementations, a memory controller may be integrated into the processor 1704. The processor 1704 may be configured to execute computer-readable instructions stored in a memory (e.g., the memory 1706) to cause the device 1702 to perform various functions of the present disclosure.

The memory 1706 may include random access memory (RAM) and read-only memory (ROM). The memory 1706 may store computer-readable, computer-executable code including instructions that, when executed by the processor 1704 cause the device 1702 to perform various functions described herein. The code may be stored in a non-transitory computer-readable medium such as system memory or another type of memory. In some implementations, the code may not be directly executable by the processor 1704 but may cause a computer (e.g., when compiled and executed) to perform functions described herein. In some implementations, the memory 1706 may include, among other things, a basic I/O system (BIOS) which may control basic hardware or software operation such as the interaction with peripheral components or devices.

The I/O controller 1710 may manage input and output signals for the device 1702. The I/O controller 1710 may also manage peripherals not integrated into the device M02. In some implementations, the I/O controller 1710 may represent a physical connection or port to an external peripheral. In some implementations, the I/O controller 1710 may utilize an operating system such as iOS®, ANDROID®, MS-DOS®, MS-WINDOWS®, OS/2®, UNIX®, LINUX®, or another known operating system. In some implementations, the I/O controller 1710 may be implemented as part of a processor, such as the processor 1704. In some implementations, a user may interact with the device 1702 via the I/O controller 1710 or via hardware components controlled by the I/O controller 1710.

In some implementations, the device 1702 may include a single antenna 1712. However, in some other implementations, the device 1702 may have more than one antenna 1712 (i.e., multiple antennas), including multiple antenna panels or antenna arrays, which may be capable of concurrently transmitting or receiving multiple wireless transmissions. The transceiver 1708 may communicate bi-directionally, via the one or more antennas 1712, wired, or wireless links as described herein. For example, the transceiver 1708 may represent a wireless transceiver and may communicate bi-directionally with another wireless transceiver. The transceiver 1708 may also include a modem to modulate the packets, to provide the modulated packets to one or more antennas 1712 for transmission, and to demodulate packets received from the one or more antennas 1712.

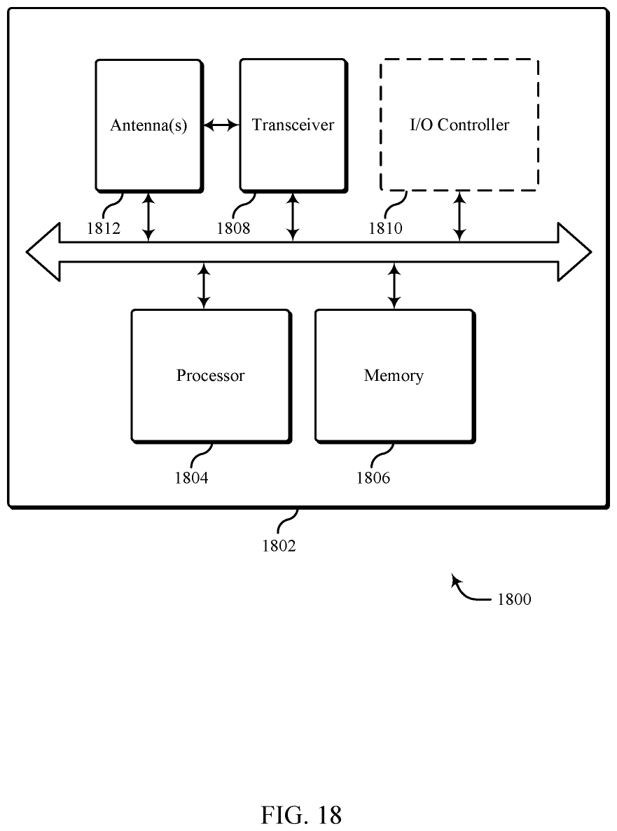

FIG. 18 illustrates an example of a block diagram 1800 of a device 1802 that supports reporting enhancements for mixed downlink transmissions in accordance with aspects of the present disclosure. The device 1802 may be an example of a network entity (NE) 102 as described herein. The device 1802 may support wireless communication with one or more network entities 102, UEs 104, or any combination thereof. The device 1802 may include components for bi-directional communications including components for transmitting and receiving communications, such as a processor 1804, a memory 1806, a transceiver 1808, and an I/O controller 1810. These components may be in electronic communication or otherwise coupled (e.g., operatively, communicatively, functionally, electronically, electrically) via one or more interfaces (e.g., buses).

The processor 1804, the memory 1806, the transceiver 1808, or various combinations thereof or various components thereof may be examples of means for performing various aspects of the present disclosure as described herein. For example, the processor 1804, the memory 1806, the transceiver 1808, or various combinations or components thereof may support a method for performing one or more of the operations described herein.

In some implementations, the processor 1804, the memory 1806, the transceiver 1808, or various combinations or components thereof may be implemented in hardware (e.g., in communications management circuitry). The hardware may include a processor, a DSP, an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1804 and the memory 1806 coupled with the processor 1804 may be configured to perform one or more of the functions described herein (e.g., executing, by the processor 1804, instructions stored in the memory 1806).

For example, the processor 1804 may support wireless communication at the device 1802 in accordance with examples as disclosed herein. The processor 1804 may be configured as or otherwise support a means for transmitting a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB; and receiving, over a physical uplink channel, a second signaling as a CSI report corresponding to at least one of the plurality of communication modes.

Additionally, the processor 1804 may be configured as or otherwise support any one or combination of the first TB is associated with a first TB error probability threshold and the second TB is associated with a second TB error probability threshold. The first TB error probability threshold is higher than the second TB error probability threshold. The first TB is associated with a first latency threshold and the second TB is associated with a second latency threshold. Transmitting one or more DL-RS based on the CSI reporting setting. The CSI configuration is indicated by at least one of: a higher-layer configuration parameter in the CSI reporting setting; a higher-layer configuration parameter in a codebook configuration associated with the CSI reporting setting; a selection of at least two CQI tables associated with different TB error probability thresholds; or a repetition scheme configuration parameter of a received PDSCH configuration, the repetition scheme configuration parameter associated with time-division multiplexing, frequency-division multiplexing, or spatial-division multiplexing. the physical uplink channel includes at least one of: a PUSCH based on at least one of an aperiodic time-domain behavior reporting configuration or a semi-persistent time-domain behavior reporting configuration; or a PUCCH based on at least one of a periodic time-domain behavior reporting configuration or a semi-persistent time-domain behavior reporting configuration. The CSI reporting setting includes an indication of a report quantity including at least one of a RI, a PMI, or a CQI. The CSI report includes a first pair of values associated with the first communication mode and a second pair of values associated with the second communication mode, the first pair of values including a first RI and a first CQI, the second pair of values including a second RI and a second CQI. The CSI report includes a first PMI corresponding to the first communication mode and a second PMI corresponding to the second communication mode. The CSI report includes a PMI corresponding to the first communication mode and the second communication mode. A first subset of layers of the PMI is associated with the first communication mode. A second subset of layers of the PMI is associated with the second communication mode. The CSI report includes a parameter indicating layer indices of at least one of the first subset of layers or the second subset of layers.

Additionally, the CSI report includes one or more pairs of values, each of the one or more pairs of values including a RI and a CQI. The one or more pairs of values include: a first pair of values associated with the first communication mode; a second pair of values associated with the second communication mode; a third pair of values associated with a first of two codewords corresponding to the third communication mode; and a fourth pair of values associated with a second of the two codewords corresponding to the third communication mode. The CSI report includes a first PMI associated with the first communication mode and a second PMI associated with the second communication mode. A first subset of layers of the first PMI is associated with a first codeword corresponding to the third communication mode. A second subset of layers of the second PMI is associated with the second codeword corresponding to the third communication mode. The CSI report includes a parameter indicating layer indices of at least one of the first subset of layers or the second subset of layers. the CSI report includes: a first layer indicator indicating a first layer index corresponding to the first subset of the layers; and a second layer indicator indicating a second layer index corresponding to the second subset of layers. A codeword corresponding to the second TB is transmitted over the PDSCH using a first set of resources associated with a first network entity and a second set of resources associated with a second network entity. The first set of resources includes time resources, frequency resources, or a pair of time and frequency resources. The second set of resources includes time resources, frequency resources, or a pair of time and frequency resources. The first communication mode corresponds to a mobile broadband communication mode. The second communication mode corresponds to at least one of a high reliability communication mode or a low latency communication mode. A codeword corresponding to the second TB is associated with two NZP-CSI-RS resources for channel measurement.

Additionally, a codeword corresponding to the second TB is associated with a DMRS that includes a first group of DMRS ports and a second group of DIRS ports. The first group of DIRS ports is quasi-co-located with a first NZP-CSI-RS resource. The second group of the DIRS ports is quasi-co-located with a second NZP-CSI-RS resource. The CSI reporting setting is configured to override one or more other CSI reporting settings received by the apparatus prior to receipt of the CSI reporting setting. A number of CSI processing units (CPUs) associated with the CSI reporting setting corresponds to a maximum number of CPUs available at the apparatus. Receiving from a UE, based at least in part on the CSI reporting setting, at least one of a first CSI report corresponding to the first communication mode, a second CSI report corresponding to the second communication mode, and a third CSI report corresponding to the third communication mode. Each of the at least one of the first CSI report, the second CSI report, and the third CSI report includes at least one of a RI, a PMI, or a CQI.

Additionally, or alternatively, the device 1802, in accordance with examples as disclosed herein, may include a processor; and a memory coupled with the processor, the processor configured to cause the device 1802 to: transmit a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB; and receive, over a physical uplink channel, a second signaling as a CSI report corresponding to at least one of the plurality of communication modes.

Additionally, the wireless communication at the device 1802 may include any one or combination of the first TB is associated with a first TB error probability threshold and the second TB is associated with a second TB error probability threshold. The first TB error probability threshold is higher than the second TB error probability threshold. The first TB is associated with a first latency threshold and the second TB is associated with a second latency threshold. The processor configured to cause the device 1802 to transmit one or more DL-RS based on the CSI reporting setting. The CSI configuration is indicated by at least one of: a higher-layer configuration parameter in the CSI reporting setting; a higher-layer configuration parameter in a codebook configuration associated with the CSI reporting setting; a selection of at least two CQI tables associated with different TB error probability thresholds; or a repetition scheme configuration parameter of a received PDSCH configuration, the repetition scheme configuration parameter associated with time-division multiplexing, frequency-division multiplexing, or spatial-division multiplexing. the physical uplink channel includes at least one of: a PUSCH based on at least one of an aperiodic time-domain behavior reporting configuration or a semi-persistent time-domain behavior reporting configuration; or a PUCCH based on at least one of a periodic time-domain behavior reporting configuration or a semi-persistent time-domain behavior reporting configuration. The CSI reporting setting includes an indication of a report quantity including at least one of a RI, a PMI, or a CQI. The CSI report includes a first pair of values associated with the first communication mode and a second pair of values associated with the second communication mode, the first pair of values including a first RI and a first CQI, the second pair of values including a second RI and a second CQI. The CSI report includes a first PMI corresponding to the first communication mode and a second PMI corresponding to the second communication mode. The CSI report includes a PMI corresponding to the first communication mode and the second communication mode. A first subset of layers of the PMI is associated with the first communication mode. A second subset of layers of the PMI is associated with the second communication mode. The CSI report includes a parameter indicating layer indices of at least one of the first subset of layers or the second subset of layers.

Additionally, the CSI report includes one or more pairs of values, each of the one or more pairs of values including a RI and a CQI. The one or more pairs of values include: a first pair of values associated with the first communication mode; a second pair of values associated with the second communication mode; a third pair of values associated with a first of two codewords corresponding to the third communication mode; and a fourth pair of values associated with a second of the two codewords corresponding to the third communication mode. The CSI report includes a first PMI associated with the first communication mode and a second PMI associated with the second communication mode. A first subset of layers of the first PMI is associated with a first codeword corresponding to the third communication mode. A second subset of layers of the second PMI is associated with the second codeword corresponding to the third communication mode. The CSI report includes a parameter indicating layer indices of at least one of the first subset of layers or the second subset of layers. the CSI report includes: a first layer indicator indicating a first layer index corresponding to the first subset of the layers; and a second layer indicator indicating a second layer index corresponding to the second subset of layers. A codeword corresponding to the second TB is transmitted over the PDSCH using a first set of resources associated with a first network entity and a second set of resources associated with a second network entity. The first set of resources includes time resources, frequency resources, or a pair of time and frequency resources. The second set of resources includes time resources, frequency resources, or a pair of time and frequency resources. The first communication mode corresponds to a mobile broadband communication mode. The second communication mode corresponds to at least one of a high reliability communication mode or a low latency communication mode. A codeword corresponding to the second TB is associated with two NZP-CSI-RS resources for channel measurement.

Additionally, a codeword corresponding to the second TB is associated with a DMRS that includes a first group of DMRS ports and a second group of DMRS ports. The first group of DMRS ports is quasi-co-located with a first NZP-CSI-RS resource. The second group of the DMRS ports is quasi-co-located with a second NZP-CSI-RS resource. The CSI reporting setting is configured to override one or more other CSI reporting settings received by the apparatus prior to receipt of the CSI reporting setting. A number of CSI processing units (CPUs) associated with the CSI reporting setting corresponds to a maximum number of CPUs available at the apparatus. The processor configured to cause the device to receive from a UE, based at least in part on the CSI reporting setting, at least one of a first CSI report corresponding to the first communication mode, a second CSI report corresponding to the second communication mode, and a third CSI report corresponding to the third communication mode. Each of the at least one of the first CSI report, the second CSI report, and the third CSI report includes at least one of a RI, a PMI, or a CQI.

The processor 1804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1804 may be configured to operate a memory array using a memory controller. In some other implementations, a memory controller may be integrated into the processor 1804. The processor 1804 may be configured to execute computer-readable instructions stored in a memory (e.g., the memory 1806) to cause the device 1802 to perform various functions of the present disclosure.

The memory 1806 may include random access memory (RAM) and read-only memory (ROM). The memory 1806 may store computer-readable, computer-executable code including instructions that, when executed by the processor 1804 cause the device 1802 to perform various functions described herein. The code may be stored in a non-transitory computer-readable medium such as system memory or another type of memory. In some implementations, the code may not be directly executable by the processor 1804 but may cause a computer (e.g., when compiled and executed) to perform functions described herein. In some implementations, the memory 1806 may include, among other things, a basic I/O system (BIOS) which may control basic hardware or software operation such as the interaction with peripheral components or devices.

The I/O controller 1810 may manage input and output signals for the device 1802. The I/O controller 1810 may also manage peripherals not integrated into the device 1802. In some implementations, the I/O controller 1810 may represent a physical connection or port to an external peripheral. In some implementations, the I/O controller 1810 may utilize an operating system such as iOS®, ANDROID®, MS-DOS®, MS-WINDOWS®, OS/2®, UNIX®, LINUX®, or another known operating system. In some implementations, the I/O controller 1810 may be implemented as part of a processor, such as the processor 1804. In some implementations, a user may interact with the device 1802 via the I/O controller 1810 or via hardware components controlled by the I/O controller 1810.

In some implementations, the device 1802 may include a single antenna 1812. However, in some other implementations, the device 1802 may have more than one antenna 1812 (i.e., multiple antennas), including multiple antenna panels or antenna arrays, which may be capable of concurrently transmitting or receiving multiple wireless transmissions. The transceiver 1808 may communicate bi-directionally, via the one or more antennas 1812, wired, or wireless links as described herein. For example, the transceiver 1808 may represent a wireless transceiver and may communicate bi-directionally with another wireless transceiver. The transceiver 1808 may also include a modem to modulate the packets, to provide the modulated packets to one or more antennas 1812 for transmission, and to demodulate packets received from the one or more antennas 1812.

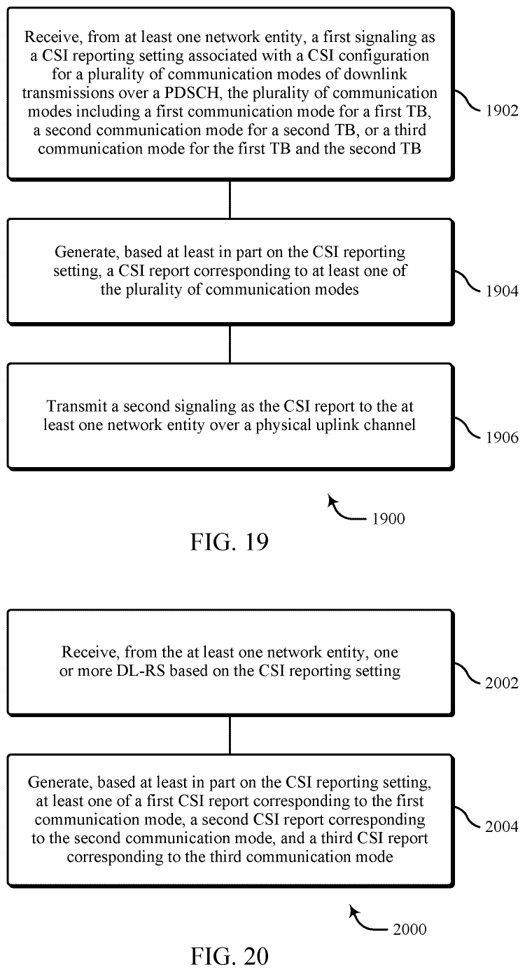

FIG. 19 illustrates a flowchart of a method 1900 that supports reporting enhancements for mixed downlink transmissions in accordance with aspects of the present disclosure. The operations of the method 1900 may be implemented by a device or its components as described herein. For example, the operations of the method 1900 may be performed by a UE 104 as described with reference to FIGS. 1 through 18. In some implementations, the device may execute a set of instructions to control the function elements of the device to perform the described functions. Additionally, or alternatively, the device may perform aspects of the described functions using special-purpose hardware.

At 1902, the method may include receiving, from at least one network entity, a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB. The operations of 1902 may be performed in accordance with examples as described herein. In some implementations, aspects of the operations of 1902 may be performed by a device as described with reference to FIG. 1.

At 1904, the method may include generating, based at least in part on the CSI reporting setting, a CSI report corresponding to at least one of the plurality of communication modes. The operations of 1904 may be performed in accordance with examples as described herein. In some implementations, aspects of the operations of 1904 may be performed by a device as described with reference to FIG. 1.

At 1906, the method may include transmitting a second signaling as the CSI report to the at least one network entity over a physical uplink channel. The operations of 1906 may be performed in accordance with examples as described herein. In some implementations, aspects of the operations of 1906 may be performed by a device as described with reference to FIG. 1.

FIG. 20 illustrates a flowchart of a method 2000 that supports reporting enhancements for mixed downlink transmissions in accordance with aspects of the present disclosure. The operations of the method 2000 may be implemented by a device or its components as described herein. For example, the operations of the method 2000 may be performed by a UE 104 as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2002, the method may include receiving, from the at least one network entity, one or more DL-RS based on the CSI reporting setting. The operations of 2002 may be performed in accordance with examples as described herein. In some implementations, aspects of the operations of 2002 may be performed by a device as described with reference to FIG. 1.

At 2004, the method may include generating, based at least in part on the CSI reporting setting, at least one of a first CSI report corresponding to the first communication mode, a second CSI report corresponding to the second communication mode, and a third CSI report corresponding to the third communication mode. The operations of 2004 may be performed in accordance with examples as described herein. In some implementations, aspects of the operations of 2004 may be performed by a device as described with reference to FIG. 1.

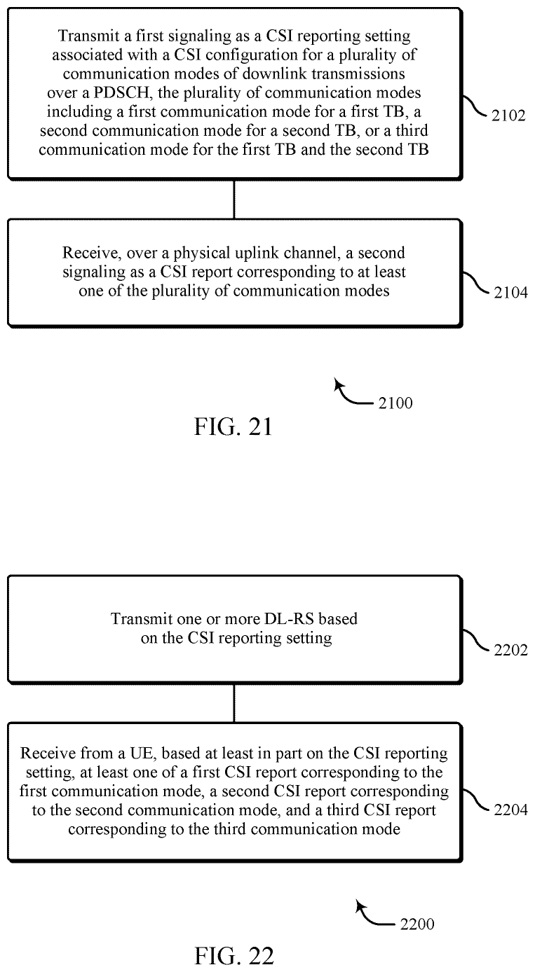

FIG. 21 illustrates a flowchart of a method 2100 that supports reporting enhancements for mixed downlink transmissions in accordance with aspects of the present disclosure. The operations of the method 2100 may be implemented by a device or its components as described herein. For example, the operations of the method 2100 may be performed by a network entity 102 as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2102, the method may include transmitting a first signaling as a CSI reporting setting associated with a CSI configuration for a plurality of communication modes of downlink transmissions over a PDSCH, the plurality of communication modes including a first communication mode for a first TB, a second communication mode for a second TB, or a third communication mode for the first TB and the second TB. The operations of 2102 may be performed in accordance with examples as described herein. In some implementations, aspects of the operations of 2102 may be performed by a device as described with reference to FIG. 1.

At 2104, the method may include receiving, over a physical uplink channel, a second signaling as a CSI report corresponding to at least one of the plurality of communication modes. The operations of 2104 may be performed in accordance with examples as described herein. In some implementations, aspects of the operations of 2104 may be performed by a device as described with reference to FIG. 1.

FIG. 22 illustrates a flowchart of a method 2200 that supports reporting enhancements for mixed downlink transmissions in accordance with aspects of the present disclosure. The operations of the method 2200 may be implemented by a device or its components as described herein. For example, the operations of the method 2200 may be performed by a network entity 102 as described with reference to FIGS. 1 through 18. In some implementations, the device may execute a set of instructions to control the function elements of the device to perform the described functions. Additionally, or alternatively, the device may perform aspects of the described functions using special-purpose hardware.

At 2202, the method may include transmitting one or more DL-RS based on the CSI reporting setting. The operations of 2202 may be performed in accordance with examples as described herein. In some implementations, aspects of the operations of 2202 may be performed by a device as described with reference to FIG. 1.

At 2204, the method may include receiving from a UE, based at least in part on the CSI reporting setting, at least one of a first CSI report corresponding to the first communication mode, a second CSI report corresponding to the second communication mode, and a third CSI report corresponding to the third communication mode. The operations of 2204 may be performed in accordance with examples as described herein. In some implementations, aspects of the operations of 2204 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a channel state information (CSI) reporting setting associated with a CSI configuration for a plurality of communication modes of downlink transmissions over a physical downlink shared channel (PDSCH), the plurality of communication modes including a first communication mode for a first transport block (TB), a second communication mode for a second TB, or a third communication mode for the first TB and the second TB;
generate, based at least in part on the CSI reporting setting, a CSI report corresponding to at least one of the plurality of communication modes; and
transmit the CSI report over a physical uplink channel.

2. The UE of claim 1, wherein the first TB is associated with a first TB error probability threshold and the second TB is associated with a second TB error probability threshold.

3. The UE of claim 1, wherein the first TB is associated with a first latency threshold and the second TB is associated with a second latency threshold.

4. The UE of claim 1, wherein the at least one processor is operable to cause the UE to receive one or more downlink reference signals (DL-RS) based on the CSI reporting setting.

5. The UE of claim 1, wherein the CSI configuration is indicated by at least one of:
a higher-layer configuration parameter in the CSI reporting setting;
a higher-layer configuration parameter in a codebook configuration associated with the CSI reporting setting;
a selection of at least two channel quality indicator (CQI) tables associated with different TB error probability thresholds; or
a repetition scheme configuration parameter of a received PDSCH configuration, the repetition scheme configuration parameter associated with time-division multiplexing, frequency-division multiplexing, or spatial-division multiplexing.

6. The UE of claim 1, wherein the physical uplink channel includes at least one of:
a physical uplink shared channel (PUSCH) based on at least one of an aperiodic time-domain behavior reporting configuration or a semi-persistent time-domain behavior reporting configuration; or
a physical uplink control channel (PUCCH) based on at least one of a periodic time-domain behavior reporting configuration or the semi-persistent time-domain behavior reporting configuration.

7. The UE of claim 1, wherein the CSI reporting setting includes an indication of a report quantity including at least one of a rank indicator (RI), a precoding matrix indicator (PMI), or a channel quality indicator (CQI).

8. The UE of claim 7, wherein the CSI report includes a first pair of values associated with the first communication mode and a second pair of values associated with the second communication mode, the first pair of values including a first RI and a first CQI, the second pair of values including a second RI and a second CQI.

9. The UE of claim 1, wherein:
the CSI report includes one or more pairs of values, each of the one or more pairs of values including a rank indicator (RI) and a channel quality indicator (CQI); and
the one or more pairs of values include:
a first pair of values associated with the first communication mode;
a second pair of values associated with the second communication mode;
a third pair of values associated with a first of two codewords corresponding to the third communication mode; and
a fourth pair of values associated with a second of the two codewords corresponding to the third communication mode.

10. The UE of claim 1, wherein:
the CSI report includes a first precoding matrix indicator (PMI) associated with the first communication mode and a second PMI associated with the second communication mode;
a first subset of layers of the first PMI is associated with a first codeword corresponding to the third communication mode; and
a second subset of layers of the second PMI is associated with a second codeword corresponding to the third communication mode.

11. The UE of claim 1, wherein a codeword corresponding to the second TB is transmitted over the PDSCH using a first set of resources associated with a first network entity and a second set of resources associated with a second network entity, and wherein each of the first set of resources and the second set of resources includes at least one of time resources, frequency resources, or a pair of time and frequency resources.

12. The UE of claim 1, wherein:
the first communication mode corresponds to a mobile broadband communication mode; and
the second communication mode corresponds to at least one of a high reliability communication mode or a low latency communication mode.

13. The UE of claim 1, wherein a codeword corresponding to the second TB is associated with two non-zero power channel state information reference signal (NZP-CSI-RS) resources for channel measurement.

14. The UE of claim 1, wherein:
a codeword corresponding to the second TB is associated with a demodulation reference signal (DMRS) that includes a first group of DMRS ports and a second group of DMRS ports;
the first group of DMRS ports is quasi-co-located with a first non-zero power channel state information reference signal (NZP-CSI-RS) resource; and
the second group of the DMRS ports is quasi-co-located with a second NZP-CSI-RS resource.

15. The UE of claim 1, wherein the CSI reporting setting is configured to override one or more other CSI reporting settings received by the UE prior to receipt of the CSI reporting setting.

16. The UE of claim 1, wherein a number of CSI processing units (CPUs) associated with the CSI reporting setting corresponds to a maximum number of CPUs available at the UE.

17. The UE of claim 1, wherein the at least one processor is operable to cause the UE to generate, based at least in part on the CSI reporting setting, at least one of a first CSI report corresponding the first communication mode, a second CSI report corresponding to the second communication mode, or a third CSI report corresponding to the third communication mode.

18. (canceled)

19. A network entity (NE) for wireless communication, comprising:
at least one memory; and
at least one processor coupled with the at least one memory and operable to cause the NE to:
transmit a channel state information (CSI) reporting setting associated with a CSI configuration for a plurality of communication modes of downlink transmissions over a physical downlink shared channel (PDSCH), the plurality of communication modes including a first communication mode for a first transport block (TB), a second communication mode for a second TB, or a third communication mode for the first TB and the second TB; and
receive, over a physical uplink channel, a CSI report corresponding to at least one of the plurality of communication modes.

20. A method performed by a user equipment (UE), the method comprising:
receiving a channel state information (CSI) reporting setting associated with a CSI configuration for a plurality of communication modes of downlink transmissions over a physical downlink shared channel (PDSCH), the plurality of communication modes including a first communication mode for a first transport block (TB), a second communication mode for a second TB, or a third communication mode for the first TB and the second TB;
generating, based at least in part on the CSI reporting setting, a CSI report corresponding to at least one of the plurality of communication modes; and
transmitting the CSI report over a physical uplink channel.

21. A method performed by a network entity (NE), the method comprising:
transmitting a channel state information (CSI) reporting setting associated with a CSI configuration for a plurality of communication modes of downlink transmissions over a physical downlink shared channel (PDSCH), the plurality of communication modes including a first communication mode for a first transport block (TB), a second communication mode for a second TB, or a third communication mode for the first TB and the second TB; and
receive, over a physical uplink channel, a CSI report corresponding to at least one of the plurality of communication modes.
